(19) United States
(12) Patent Application Publication
(10) Pub. No.: US 2026/0231153 A1
(43) Pub. Date: Aug. 6, 2026

(54) INTERMEDIATE ACCESS CONTROL FOR SELF-SCHEDULED USER EQUIPMENT TRANSMISSIONS

(71) Applicant: QUALCOMM Incorporated, San Diego, CA (US)

(72) Inventors: Raviteja PATCHAVA, San Diego, CA (US); Jing SUN, San Diego, CA (US); Diana MAAMARI, San Diego, CA (US); Jing JIANG, San Diego, CA (US)

(21) Appl. No.: 19/045,145

(22) Filed: Feb. 4, 2025

(51) Int. Cl. H04W 72/21; H04W 72/044

(52) U.S. Cl. CPC H04W 72/21; H04W 72/044

(57) ABSTRACT

Aspects of the present disclosure provide techniques for intermediate access control for self-scheduled user equipment (UE) transmissions. A method performed by a network entity includes transmitting resource configuration information configuring an uplink control information (UCI) resource pool including time-frequency resources for transmitting UCI and a separate physical uplink shared channel (PUSCH) resource pool including time-frequency resources for transmitting data transmissions, receiving, from a first UE, a first UCI in a first time-frequency resource included in the UCI resource pool requesting access to a first time-frequency resource included in the PUSCH resource pool to transmit a first data transmission, transmitting, to the first UE, grant information indicating that the access to the first time-frequency resource included in the PUSCH resource pool has been granted to transmit the first data transmission, and receiving, from the first UE, the first data transmission in the first time-frequency resource included in the PUSCH resource pool.

### BACKGROUND

### Field of the Disclosure

Aspects of the present disclosure relate to wireless communications, and more particularly, to techniques for intermediate access control for self-scheduled user equipment (UE) transmissions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a network entity. The method includes transmitting, to one or more user equipments (UEs), resource configuration information configuring an uplink control information (UCI) resource pool including time-frequency resources for transmitting UCI and a separate physical uplink shared channel (PUSCH) resource pool including time-frequency resources for transmitting data transmissions; receiving, from a first UE of the one or more UEs, a first UCI in a first time-frequency resource included in the UCI resource pool requesting access to a first time-frequency resource included in the PUSCH resource pool to transmit a first data transmission; transmitting, to the first UE after receiving the first UCI, grant information indicating that the access to the first time-frequency resource included in the PUSCH resource pool has been granted to transmit the first data transmission; and receiving, from the first UE, the first data transmission in the first time-frequency resource included in the PUSCH resource pool after transmitting the grant information.

Another aspect provides a method for wireless communication by a first user equipment (UE). The method includes receiving, from a network entity, resource configuration information configuring an uplink control information (UCI) resource pool including time-frequency resources for transmitting UCI and a separate physical uplink shared channel (PUSCH) resource pool including time-frequency resources for transmitting data transmissions; transmitting, to the network entity, a first UCI in a first time-frequency resource included in the UCI resource pool requesting access to a first time-frequency resource included in the PUSCH resource pool to transmit a first data transmission; receiving, from the network entity after transmitting the first UCI, grant information indicating that the access to the first time-frequency resource included in the PUSCH resource pool has been granted to transmit the first data transmission; and transmitting the first data transmission in the first time-frequency resource included in the PUSCH resource pool after receiving the grant information.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a process flow including operations for communications in a network between a network entity, a first user equipment, and a second user equipment.

FIG. 6 illustrates a one-to-one resource mapping between an uplink control information (UCI) resource pool and a physical uplink shared channel (PUSCH) resource pool.

FIG. 7 illustrates a multiple-to-one resource mapping between a UCI resource pool and a PUSCH resource pool.

FIG. 8 illustrates a bitmap that may be included in grant information.

FIG. 9 illustrates example downlink control information (DCI) for allocating a time-frequency resource included in a PUSCH resource pool.

FIG. 10 illustrates an example list of identifiers that may be included within grant information.

FIG. 11 illustrates another example list of identifiers that may be included within grant information.

FIG. 12 illustrates another example DCI for allocating a time-frequency resource included in a PUSCH resource pool.

FIG. 13 illustrates another example list of identifiers that may be included within grant information.

FIG. 14 depicts a method for wireless communications.

FIG. 15 depicts a method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for intermediate access control for self-scheduled user equipment (UE) transmissions.

The increasing deployment of IoT devices has led to a rise in uplink (UL) transmissions from user equipments (UEs) to network entities, traditionally managed through per-UE scheduling, where a network entity individually assigns resources for each UE. While effective, this approach generates significant signaling overhead, particularly in high-density networks. To mitigate this, configured grant (CG) mechanisms enable UEs to self-schedule their UL transmissions by selecting resources from a predefined pool, reducing downlink (DL) control signaling and conserving network resources.

However, self-scheduling introduces challenges such as resource collisions, where multiple UEs may select the same time-frequency resource, leading to interference and degraded performance. Additionally, the network entity must perform blind decoding across all resources in the configured pool, creating a substantial processing burden, particularly in large-scale deployments. To address this, a self-decodable uplink control information (UCI) mechanism allows UEs to transmit UCI with each resource selection, including a cyclic redundancy check (CRC) to facilitate independent decoding. This enables the network entity to extract critical information—such as modulation and coding scheme (MCS) and UE identity—before decoding the associated UL transmission, improving efficiency. However, while self-decodable UCI reduces processing complexity, it does not eliminate collisions, which may still result in failed decoding and power losses for affected UEs.

Accordingly, aspects of the present disclosure provide an intermediate access control mechanism to help address the challenges associated with collisions between UEs when using a self-scheduling framework that may be used to manage access to time-frequency resources used to transmit UL data transmissions. In some cases, the intermediate access control mechanism may involve the use of separate resource pools, such as a physical uplink shared channel (PUSCH) resource pool and a UCI resource pool. For example, the PUSCH resource pool may include time-frequency resources for transmission UL data transmissions by one or more UEs while the UCI resource pool may include time-frequency resources that may be used by the one or more UEs to transmitting UCI to request access to one or more time-frequency resources in the PUSCH resource pool to transmit the UL data transmissions.

In some cases, a network entity may use the intermediate access control mechanism to avoid resource collisions in the PUSCH resource pool by selectively managing (e.g., granting or denying) access to the time-frequency resource included in the PUSCH resource pool. For example, when multiple UEs request access to the same time-frequency resource of the PUSCH resource pool, the network entity may use the intermediate access control mechanism to either deny access to the resource altogether or grant access to only one UE, avoiding collisions of UL data transmissions from the multiple UEs and thereby improving power efficiency and enhancing overall system performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

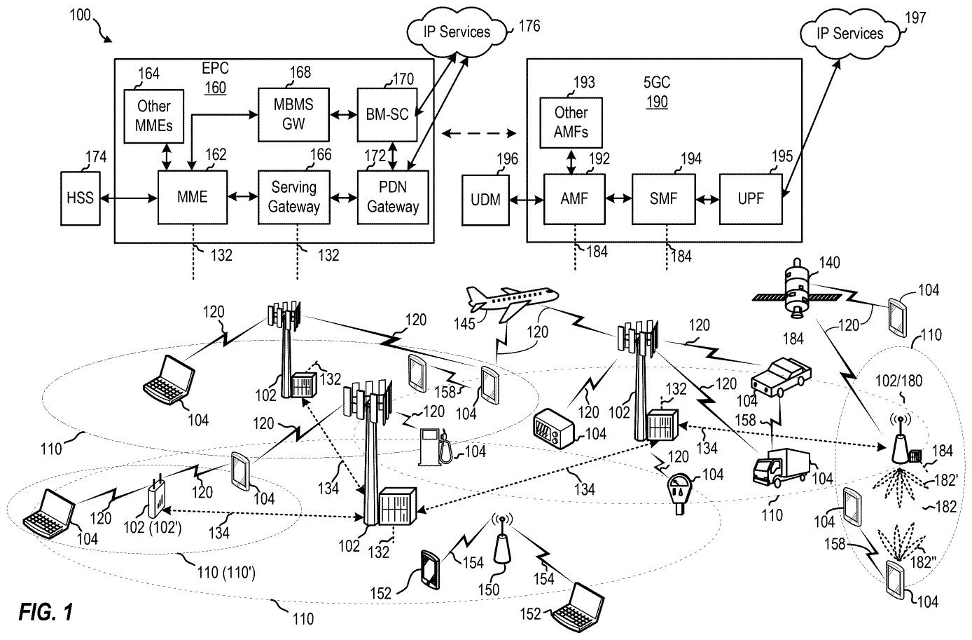

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

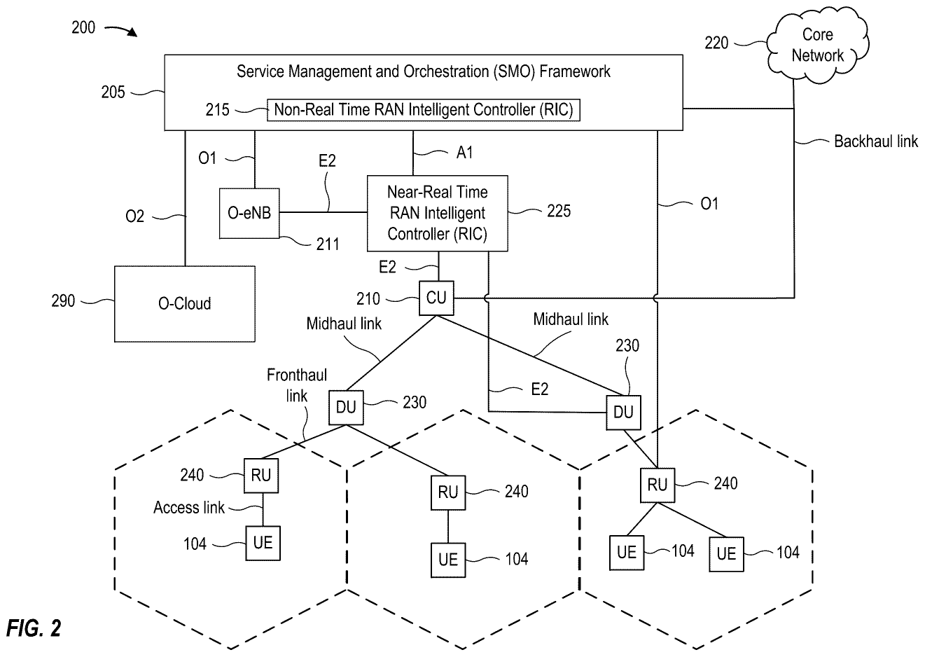

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

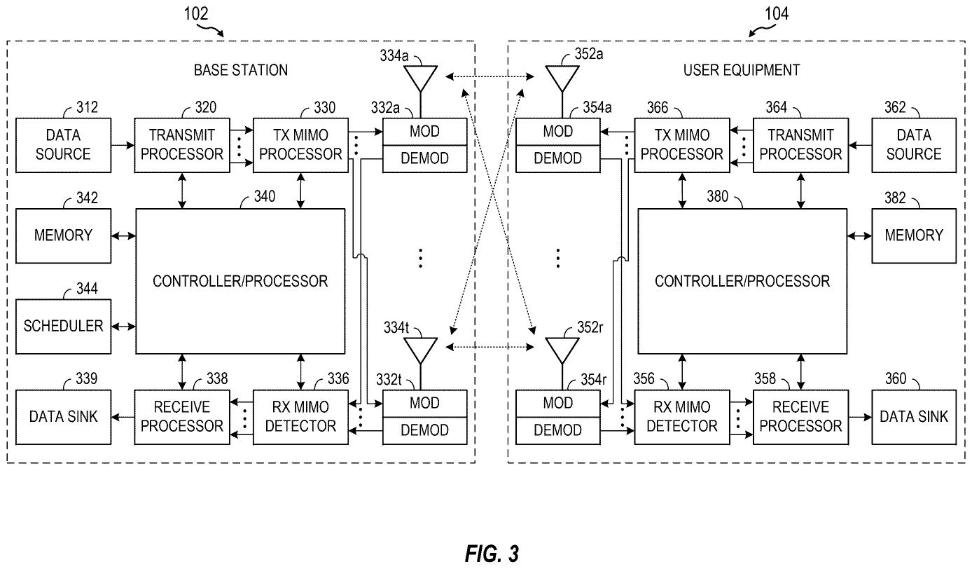

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

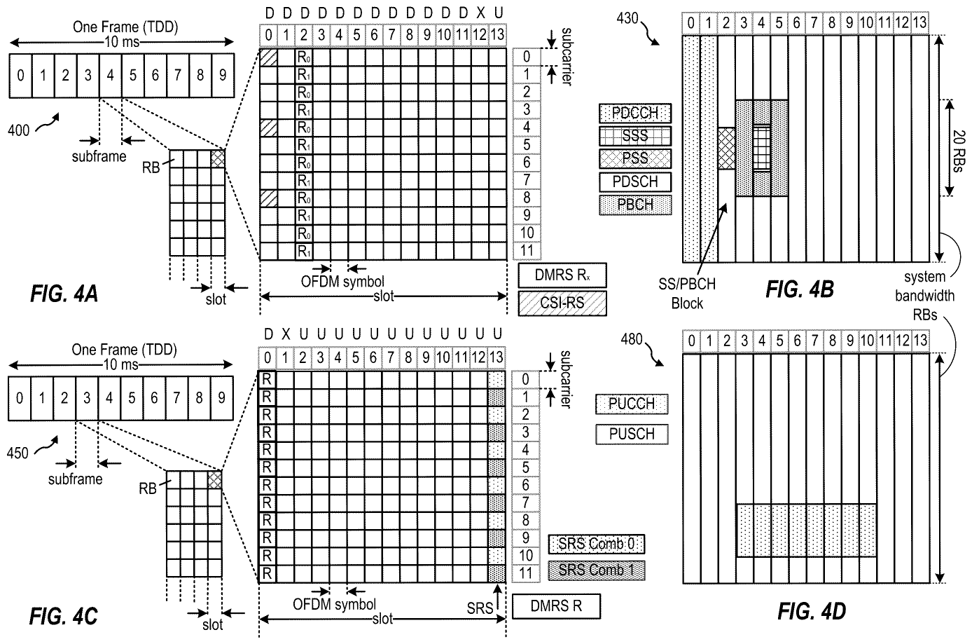

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Intermediate Access Control for Self-Scheduled UE Transmissions

The advent of internet of things (IoT) devices has led to a growing number of connections between user equipments (UEs) (e.g., UE 104) and network entities (e.g., BS 102) within in cellular networks. To manage uplink (UL) transmissions from these UEs efficiently, conventional systems rely on per-UE scheduling performed by a network entity, where the network entity individually schedules UL transmissions for each UE based on specific requirements and available network resources. However, per-UE scheduling necessitates a substantial amount of control signaling, especially when dealing with a high density of UEs, leading to significant signaling overhead.

To mitigate this overhead, an alternative approach may be an enhancement of configured grant (CG) mechanisms involving UEs self-scheduling their UL transmissions. By allowing UEs to choose transmission resources directly, the network entity may reduce downlink (DL) control signaling, thereby saving power and conserving network resources. Nonetheless, full flexibility for UE self-scheduling may be impractical, as the network entity must still provide predefined configurations and resource pools for UL transmissions for these UEs, striking a balance between flexibility and resource control.

In a self-scheduling framework, a UE may be configured to select a time-frequency resource from a configured resource pool based on its payload size and modulation and coding scheme (MCS) requirements. Thereafter, the UE may proceed ahead with transmitting an UL transmission using the selected resource without requiring additional scheduling information from the network entity. While this approach reduces DL control overhead, it may introduce challenges such as resource collisions, where multiple UEs may inadvertently select and use the same time-frequency resource in the resource pool. Such collisions may result in interference, degraded performance, and power inefficiency.

Further, while UE self-scheduling may reduce the overhead associated with DL control signaling, it may increase a processing burden by the network entity, as the network entity will be required to perform blind decoding across all resources in the configured resource pool to receive and decode UL transmissions from one or more UEs. As the scale of deployments grows, this processing burden can quickly become unmanageable, limiting the feasibility of such self-scheduling methods for large-scale networks.

In some cases, to reduce the processing burden associated with blind decoding, a self-decodable uplink control information (UCI) mechanism may be used. For example, in some cases, a UE may be configured to transmit a UCI within each time-frequency resource of the configured resource pool or allocated through a separate UCI resource pool. Each UCI may include its own cyclic redundancy check (CRC), enabling independent decoding by the network entity. By decoding the UCI first using blind decoding, the network entity may be able to extract critical information such as the modulation and coding scheme (MCS), UE ID, and unit ID. This information may then be used to efficiently decode an associated UL data transmission, thereby reducing the overall complexity of processing and improving the scalability of the self-scheduling framework. However, while this self-decodable UCI approach may simplify processing at the network entity, it may not address collisions between UEs that select the same time-frequency resource within the configured resource pool to transmit an UL data transmission. For example, if a collision between UEs occurs, the network entity may fail to decode both the UCI and UL data transmission, leading to power losses for the collided users.

Accordingly, aspects of the present disclosure provide techniques to help address the challenges associated with collisions between UEs when using a self-scheduling framework that may be used to manage access to time-frequency resources used to transmit UL data transmissions. In some cases, the intermediate access control mechanism may involve the use of separate resource pools, such as a physical uplink shared channel (PUSCH) resource pool and a UCI resource pool. For example, the PUSCH resource pool may include time-frequency resources for transmission UL data transmissions by one or more UEs while the UCI resource pool may include time-frequency resources that may be used by the one or more UEs to transmitting UCI to request access to one or more time-frequency resources in the PUSCH resource pool to transmit the UL data transmissions.

Accordingly, in some cases, each UE may first request one or more time-frequency resources included in the PUSCH resource pool using a UCI transmitted in the UCI resource pool. The network entity may then use the intermediate access control mechanism to avoid resource collisions in the PUSCH resource pool by selectively managing access to the time-frequency resource included in the PUSCH resource pool. For example, in some cases, when multiple UEs select the same time-frequency resource in the PUSCH resource pool for transmitting an UL data transmission (e.g., which may be referred to as a resource collision), the network entity may use the intermediate access control mechanism to either deny access to the resource altogether or grant access to only one UE, avoiding collisions of UL data transmissions from multiple UEs and thereby improving power efficiency and enhancing overall system performance.

Thereafter, the network entity may transmit grant information indicating which time-frequency resources included in the PUSCH resource pool have been granted. The UEs associated with the time-frequency resources included in the PUSCH resource pool that have been granted may then use these resources to transmit the UL data transmissions.

### Example Operations of Entities in a Communications Network

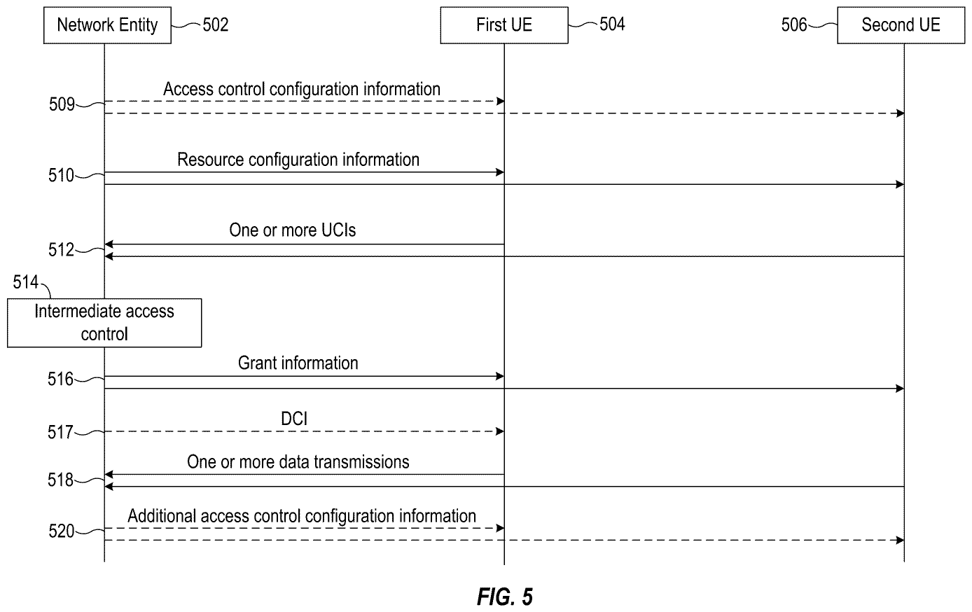

FIG. 5 depicts a process flow including operations 500 for communications in a network between a network entity 502 and one or more UEs, such as a first user equipment (UE) 504 and a second UE 506. In some aspects, the network entity 502 may be an example of the BS 102 depicted and described with respect to FIGS. 1 and 3 or a disaggregated base station depicted and described with respect to FIG. 2. Similarly, the first UE 504 and the second UE 506 may be an examples of UE 104 depicted and described with respect to FIGS. 1 and 3. However, in other aspects, first UE 504 and the second UE 506 may be another type of wireless communications device and network entity 502 may be another type of network entity or network node, such as those described herein.

As shown, operations 500 begin at 510 with the network entity 502 transmitting, to one or more UEs, such as the first UE 504 and the second UE 506, resource configuration information configuring a plurality of separate resource pools. For example, in some cases, the resource configuration information may configure a UCI resource pool and separate PUSCH resource pool. In some cases, the PUSCH resource pool may include time-frequency resources for transmitting data transmissions by the one or more UEs. Additionally, in some cases, the UCI resource pool may include time-frequency resources that may be used for transmitting UCI by the one or more UEs to request access to one or more time-frequency resources included within PUSCH resource pool for transmitting the data transmissions.

In some cases, the time-frequency resources included in the UCI resource pool may be mapped to the time-frequency resources included in the PUSCH resource pool based on a UCI-to-PUSCH resource mapping. In some cases, the UCI-to-PUSCH resource mapping may be used to implicitly indicate a time-frequency resource included in the PUSCH resource pool for which access is being requested based on a time-frequency resource in which a UCI is transmitted/received in the UCI resource pool, as explained further below.

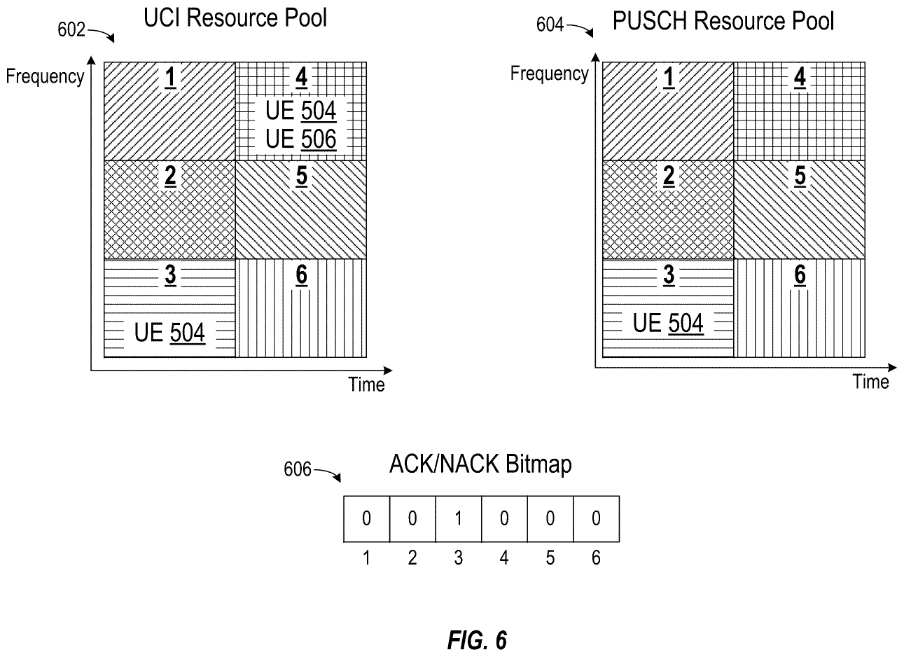

In some cases, as shown in FIG. 6, the UCI-to-PUSCH resource mapping may include a one-to-one resource mapping in which one time-frequency resource included in the UCI resource pool maps to one time-frequency resource included in the PUSCH resource pool. For example, FIG. 6 illustrates a UCI resource pool 602 and a PUSCH resource pool 604. As shown, the UCI resource pool 602 includes time-frequency resources (e.g., labeled 1 through 6), which may be used by the one or more UEs to transmit UCI. Additionally, as shown, the PUSCH resource pool 604 includes time-frequency resources (e.g., also labeled 1 through 6), which may be used by the one or more UEs to transmit data transmissions. In some cases, as shown, a total quantity of the time-frequency resources included in the UCI resource pool 602 may be equal to a total quantity of the time-frequency resources included in the PUSCH resource pool 604. In some cases, an actual total number of time-frequency resource elements (Res) for UCI may be much lower than PUSCH as each UCI resource may only require few REs to transmit compared the data transmissions in each PUSCH resource. In other words, while the total quantity of time-frequency resources included in the UCI resource pool 602 may be equal to the total quantity of the time-frequency resources included in the PUSCH resource pool 604, a total number of REs included within each of the time-frequency resources of the PUSCH resource pool 604 may be greater than a total number of Res included within each of the time-frequency resources of the UCI resource pool 602.

Further, as represented by the similar patterned shading, the time-frequency resources included in the UCI resource pool 602 may map to the time-frequency resources included in the PUSCH resource pool 604 according to a one-to-one mapping. For example, time-frequency resource #1 included in the UCI resource pool 602 may map to time-frequency resource #1 included in the PUSCH resource pool 604, time-frequency resource #2 included in the UCI resource pool 602 may map to time-frequency resource #2 included in the PUSCH resource pool 604, and so on.

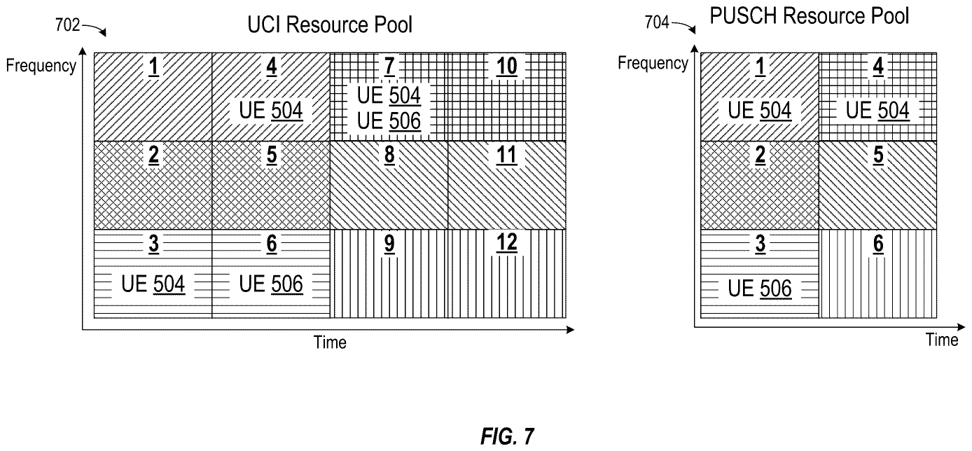

In some cases, as shown in FIG. 7, the UCI-to-PUSCH resource mapping may comprise a multiple-to-one resource mapping in which multiple different time-frequency resources included in the UCI resource pool map to one time-frequency resource included in the PUSCH resource pool. For example, FIG. 7 illustrates a UCI resource pool 702 and a PUSCH resource pool 704. As shown, the UCI resource pool 702 includes time-frequency resources (e.g., labeled 1 through 12), which may be used by the one or more UEs to transmit UCI. Additionally, as shown, the PUSCH resource pool 704 includes time-frequency resources (e.g., also labeled 1 through 6), which may be used by the one or more UEs to transmit data transmissions. In some cases, as shown, a total quantity of the time-frequency resources included in the UCI resource pool 702 may be greater than a total quantity of the time-frequency resources included in the PUSCH resource pool 704.

Further, as represented by the similar patterned shading, the time-frequency resources included in the UCI resource pool 702 may map to the time-frequency resources included in the PUSCH resource pool 704 according to a multiple-to-one mapping. In the example shown in FIG. 7, two time-frequency resources included in the UCI resource pool 702 may map to one time-frequency resource included in the PUSCH resource pool 704. For example, as shown, time-frequency resources #1 and #4 included in the UCI resource pool 702 may map to time-frequency resource #1 included in the PUSCH resource pool 704, time-frequency resources #2 and #5 included in the UCI resource pool 702 may map to time-frequency resource #2 included in the PUSCH resource pool 704, and so on.

Thereafter, as shown at 512, the network entity 502 may receive, from the one or more UEs, one or more UCIs transmitted in the time-frequency resources of the UCI resource pool that request access to one or more time-frequency resources included in the PUSCH resource pool for transmitting one or more data transmissions. In some cases, the one or more UCIs may each implicitly request access to a particular time-frequency resource included in the PUSCH resource pool based on the time-frequency resources of the UCI resource pool in which they are received, for example, according to the UCI-to-PUSCH resource mapping. In some cases, receiving the one or more UCIs may involve performing blind decoding across the UCI resource pool to decode the one or more UCIs based on CRC information included in the one or more UCIs.

In some cases, the one or more UCIs may be transmitted using one of a physical uplink control channel (PUCCH) waveform or a PUSCH waveform. In some cases, the one or more UCIs may each include cyclic redundancy check (CRC) information, allowing for the network entity 502 to independently decode each received UCI. In some cases, the one or more UCIs may each include one or more transmission parameters requested for transmitting the one or more data transmissions. In some cases, the one or more transmission parameters include at least one of a modulation and coding scheme (MCS) or a payload size. Further, in some cases, to assist with collision handling (e.g., when multiple UEs request access to the same time-frequency resource included in the PUSCH resource pool and/or multiple UEs transmit a UCI within the same time-frequency resource included in the UCI resource pool), the one or more UCIs may each include identification information that uniquely identifies each of the UCIs. In some cases, the identification information may include a UE identifier (ID), such as a cell radio network temporary identifier (C-RNTI) and/or an initial radio network temporary identifier (I-RNTI). In some cases, the identification information may include an ID that may be shorter than and different from RNTI. In some cases, the length of this ID may long enough to reduce collisions between UEs. In some cases, the identification information may include a UCI identifier.

As shown at 514, after receiving the one or more UCIs, the network entity 502 may be configured to use an intermediate access control mechanism to determine whether to grant access to the one or more time-frequency resources included in the PUSCH resource pool that are requested in the one or more UCIs. For example, in some cases, after decoding the one or more UCIs, the network entity 502 may have an understanding of which time-frequency resources in the PUSCH resource pool that are requested to be used for transmitting the one or more data transmissions. In some cases, the network entity 502 may use the intermediate access control mechanism to avoid collisions in the PUSCH resource pool. For example, in some cases, when the network entity receives and successfully decodes multiple UCIs from multiple UEs that request access to the same time-frequency resource in the PUSCH resource pool to transmit a data transmission, the network entity 502 may be configured to select and grant access to one of the multiple UEs that have requested access to the time-frequency resource in the PUSCH resource pool or may deny access to the time-frequency resource in the PUSCH resource pool altogether.

In some cases, when the network entity receives multiple UCIs from multiple UEs within the same time-frequency resource included in the UCI resource pool (e.g., and requesting access to the same time-frequency resource within the PUSCH resource pool), there may be some scenarios in which only one of the UCIs may be successfully decoded while decoding of the other UCIs may fail, for example, due to collision and these UCIs having a low signal to interference noise ratio (SINR). In such cases, the network entity 502 may be configured to use the intermediate access control mechanism to select and grant access to a requested time-frequency resource in the PUSCH resource pool for the UE associated with the successfully decoded UCI.

As shown at 516, after using the intermediate control mechanism to determine whether or not to grant access to the one or more time-frequency resources that were requested in the PUSCH resource pool, the network entity 502 may transmit one or more messages including grant information, via a media access control-control element (MAC-CE) and/or a group common physical downlink control channel (GC-PDCCH), to the one or more UEs. In some cases, the grant information may indicate whether or not access has been granted to each of the one or more one or more time-frequency resources included in the PUSCH resource pool for which access was requested to transmit the one or more data transmissions.

Thereafter, as shown at 518, the network entity may receive the one or more data transmissions from the one or more UEs based on the grant information.

In some cases, the network entity 502 may use the intermediate access control mechanism and indicate whether or not access has been granted in the grant information in different manners.

For example, as illustrated in FIG. 6, when the one-to-one mapping is used to map the time-frequency resources of the UCI resource pool to the time-frequency resources of the PUSCH resource pool, the grant information transmitted at 516 in FIG. 5 may include a bitmap 606. In some cases, the bitmap 606 includes a plurality of bits that may be used to provide access grant information, such as acknowledgement (ACK) information or negative acknowledgement (NACK) information, indicating whether time-frequency resources of the UCI resource pool are associated with successfully decoded UCI and which time-frequency resources of the PUSCH resource pool have been granted access to. For example, in some cases, a bit value of 1 (e.g., ACK) may indicate that a UCI received in a particular time-frequency resource of the UCI resource pool was successfully decoded by the network entity 502, which may also indicate that access to the time-frequency resource of the PUSCH resource pool that maps to the particular time-frequency resource of the UCI resource pool has been granted. In some cases, a bit value of 0 (e.g., NACK) particular time-frequency resource of the UCI resource pool may indicate that a UCI received in a particular time-frequency resource of the UCI resource pool was not successfully decoded by the network entity 502 (or that a collision between UEs occurred), which may also indicate that access to the time-frequency resource of the PUSCH resource pool that maps to the particular time-frequency resource of the UCI resource pool has not been granted.

In some cases, the plurality of bits may be equal to a quantity of the time-frequency resources included in the UCI resource pool 602 (and a quantity of the time-frequency resources included in the PUSCH resource pool 604). For example, as illustrated, the bitmap 606 includes 6 bits (e.g., labeled 1 through 6) since the UCI resource pool 602 include 6 time-frequency resources (e.g., resources 1 through 6). Further, in some cases, each bit of the plurality of bits of the bitmap 606 may map to a different time-frequency resource of the time-frequency resources included in the UCI resource pool 602 and may indicate whether access has been granted to a time-frequency resource included in the PUSCH resource pool 604 that maps to that different time-frequency resource included in the UCI resource pool 602.

For example, the first bit of the bitmap 606 (e.g., bit #1) may map to time-frequency resource #1 of the UCI resource pool 602 and may indicate whether access has been granted to time-frequency resource #1 included in the PUSCH resource pool 604. Similarly, the second bit of the bitmap 606 (e.g., bit #2) may map to time-frequency resource #2 of the UCI resource pool 602 and may indicate whether access has been granted to time-frequency resource #2 included in the PUSCH resource pool 604, and so on.

In the example of FIG. 6, the first UE 504 may transmit a first UCI in time-frequency resource #3 included in the UCI resource pool 602 requesting access to time-frequency resource #3 included in the PUSCH resource pool 604 to transmit a first data transmission. In some cases, the first UCI may implicitly request the access to time-frequency resource #3 included in the PUSCH resource pool 604 based on time-frequency resource #3 included in the UCI resource pool 602 (e.g., in which the first UCI is transmitted) being mapped to the time-frequency resource #3 included in the PUSCH resource pool 604 according to the one-to-one UCI-to-PUSCH resource mapping. In other words, due to the first UCI being transmitted in time-frequency resource #3 of the UCI resource pool 602 and because time-frequency resource #3 of the UCI resource pool 602 maps one-to-one to time-frequency resource #3 of the PUSCH resource pool 604, the first UCI may indicate that the first UE 504 is implicitly requesting access to time-frequency resource #3 of the PUSCH resource pool 604.

As can be seen in FIG. 6, only the first UCI is transmitted within time-frequency resource #3 of the UCI resource pool 602 and, as such, the network entity 502 may not detect a collision associated with time-frequency resource #3 of the PUSCH resource pool (e.g., multiple UEs are not requesting access to the same time-frequency resource in the PUSCH resource pool 604). Further, since only the first UCI is received and decoded within time-frequency resource #3 of the UCI resource pool 602, the network entity 502 may decide to grant access to time-frequency resource #3 of the PUSCH resource pool 604 by setting a bit within the bitmap 606 to indicate that access to time-frequency resource #3 of the PUSCH resource pool 604 is granted. For example, as can be seen, bit #3 of the bitmap 606 maps to time-frequency resource #3 included in the UCI resource pool 602 and may be set to a bit value of 1, indicating that the access to time-frequency resource #3 of the PUSCH resource pool 604 has been granted to the first UE 504.

In some cases, because each bit of the bitmap 606 maps to a different time-frequency resource of the UCI resource pool 602, the first UE 504 may not be required to include UE identification information within the first UCI. Instead, in some cases, when receiving the bitmap 606, the first UE 504 may be configured to determine that bit #3 of the bitmap 606 maps to the time-frequency resource #3 of the UCI resource pool in which the first UCI was transmitted by the first UE 504. The first UE 504 may then determine, based on the bit value of bit #3 of the bitmap 606, that time-frequency resource #3 of the PUSCH resource pool 604 has been granted to the first UE 504 based on the mapping between the time-frequency resource #3 of the UCI resource pool and time-frequency resource #3 of the PUSCH resource pool 604. Thereafter, as part of the one or more data transmissions shown at 518 in FIG. 5, the first UE 504 may then transmit the second data transmission to the network entity 502 in time-frequency resource #3 of the PUSCH resource pool 604 based on the bit value of bit #3 of the bitmap 606.

In contrast to time-frequency resource #3 of the UCI resource pool 602, a resource collision may occur in time-frequency resource #4 of the UCI resource pool 602, which may be managed by the network entity 502 using the intermediate access control mechanism. For example, in some cases, the network entity 502 may receive, from the first UE 504, a second UCI in time-frequency resource #4 included in the UCI resource pool 602 requesting access to time-frequency resource #4 included in the PUSCH resource pool 604 to transmit a second data transmission. Additionally, as can be seen, the network entity 502 may also receive, from the second UE 506, a third UCI in time-frequency resource #4 included in the UCI resource pool 602 requesting access to time-frequency resource #4 included in the PUSCH resource pool 604 to transmit a third data transmission.

Accordingly, as can be seen, the second UCI from the first UE 504 and the third UCI from the second UE 506 may collide in the time-frequency resource #4 included in the UCI resource pool 602. It should be appreciated that a collision may occur between UEs when (1) at least two UEs transmit a UCI within the same time-frequency resource of the UCI resource pool 602 and/or (2) at least two UEs transmit a UCI in different time-frequency resources within the UCI resource pool 602 but that request access to the same time-frequency resource within the PUSCH resource pool 604.

In some cases, the collision between the second UCI from the first UE 504 and the third UCI form the second UE 506 may result in a significant amount of interference, which may cause the network entity 502 to fail to decode both the second UCI and the third UCI. In some cases, when such a collision occurs, the network entity 502 may use the intermediate access control mechanism to manage this collision. For example, in some cases, when the network entity 502 fails to decode both the second UCI and the third UCI, the network entity 502 may include another bit in the bitmap 606, such as bit #4, that maps to the time-frequency resource #4 included in the UCI resource pool 602 and indicates that access to the time-frequency resource #4 included in the PUSCH resource pool 604 has not been granted to the first UE 504 or the second UE 506. For example, as can be seen, in this case, bit #4 of the bitmap 606 may have a bit value of 0 indicating that access has not been granted to time-frequency resource #4 included in the PUSCH resource pool 604.

In some cases, the network entity 502 may successfully decode one of the second UCI or the third UCI despite the second UCI and the third UCI colliding in the time-frequency resource #4 included in the UCI resource pool 602. In some cases, this successful decoding may be due to one of the second UCI or the third UCI having a higher signal strength as compared to the other. In such cases, rather than not granting access to time-frequency resource #4 of the PUSCH resource pool 604, the network entity 502 may instead decide to grant access to time-frequency resource #4 of the PUSCH resource pool 604 despite the collision resulting from the second UCI and the third UCI both requesting access to time-frequency resource #4 of the PUSCH resource pool 604. For example, in this case, bit #4 of the bitmap 606 may have a bit value of 1 indicating that access has been granted to time-frequency resource #4 included in the PUSCH resource pool 604. In some cases, indicating that access to time-frequency resource #4 of the PUSCH resource pool 604 has been granted may cause both the first UE 504 and the second UE 506 to transmit data transmissions within time-frequency resource #4 of the PUSCH resource pool 604, which may cause these data transmissions to collide with each other and cause interference to each other. However, in some cases, when a signal strength of one of the data transmissions is higher, the network entity 502 may still be able to successfully decode at least one of these data transmissions despite their collision.

For example, in some cases, based on bit #4 of the bitmap 606 indicating that the access to the time-frequency resource #4 of the PUSCH resource pool 604 has been granted, the network entity 502 may receive the second data transmission in the time-frequency resource #4 of the PUSCH resource pool 604 from the first UE 504. In some cases, the network entity 502 may also receive the third data transmission in the time-frequency resource #4 of the PUSCH resource pool 604 from the second UE 506. In some cases, despite the second data transmission from the first UE 504 and the third data transmission from the second UE 506 colliding within time-frequency resource #4 of the PUSCH resource pool 604, the network entity 502 may still be able to successfully decode one of the second data transmission or the third data transmission according to whichever of the second data transmission or the third data transmission has a higher signal strength. For example, in some cases, one of the second data transmission or the third data transmission may be transmitted with a lower modulation and coding scheme (MCS), allowing the data transmission with the lower MCS to be decoded as any interference to this data transmission may be undetected by the network entity 502.

As noted above, in some cases, the UCI-to-PUSCH resource mapping may comprise a multiple-to-one resource mapping, such as illustrated in FIG. 7, in which multiple different time-frequency resources included in the UCI resource pool 702 map to one time-frequency resource included in the PUSCH resource pool 704. When the multiple-to-one resource mapping is used, the network entity 502 may be able to decode UCI from multiple UEs within multiple time-frequency resources of the UCI resource pool 702 that correspond to one time-frequency of the PUSCH resource pool 704. In such cases, the network entity 502 may use the intermediate access control mechanism in different manners to avoid collisions.

For example, in some cases, when the network entity 502 receives UCI from multiple UEs within multiple time-frequency resources of the UCI resource pool 702 that correspond to one time-frequency of the PUSCH resource pool 704, the network entity 502 may be configured to transmit ACK information for only one of the time-frequency resources of the UCI resource pool 702 to avoid collision within the one time-frequency resource of the PUSCH resource pool 704. In some cases, the network entity 502 may be configured to select one of the time-frequency resources of the UCI resource pool 702 to grant access to the one time-frequency resource of the PUSCH resource pool 704 based on a signal to noise ratio (SNR) of the UCI associated with the selected time-frequency resources of the UCI resource pool 702 or a payload size indicated in the UCI (e.g., amount of time-frequency resources requested in the PUSCH resource pool 704). In some cases, the network entity 502 may also provide NACK information for the time-frequency resource of the UCI resource pool 702 that was not selected. Further, in some cases, for the time-frequency resource of the UCI resource pool 702 that was not selected, the network entity 502 may transmit a separate DCI that allocates one or more different time-frequency resources within the PUSCH resource pool 704 for one or more data transmission.

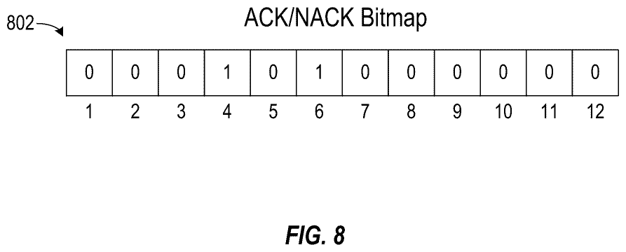

In some cases, similar to FIG. 6, the network entity 502 may provide, within the grant information transmitted at 516 in FIG. 5, the ACK/NACK information for the time-frequency resources of the UCI resource pool 602 using a plurality of bits in a bitmap, such as the bitmap 802 illustrated in FIG. 8. In some cases, the plurality of bits may be equal to a quantity of the time-frequency resources included in the UCI resource pool 702. For example, as illustrated, the bitmap 802 include 12 bits (e.g., labeled 1 through 12) since the UCI resource pool 702 includes 12 time-frequency resources (e.g., resources 1 through 12). Further, in some cases, each bit of the plurality of bits of the bitmap 802 may map to a different time-frequency resource of the time-frequency resources included in the UCI resource pool 702 and may indicate whether access has been granted to a time-frequency resource included in the PUSCH resource pool 704 that maps to that different time-frequency resource included in the UCI resource pool 702.

For example, in some cases, the bits of the bitmap 802 may map to the different time-frequency resources of the UCI resource pool according to a one-to-one mapping. For example, the first bit of the bitmap 802 (e.g., bit #1) may map to time-frequency resource #1 of the UCI resource pool 702 and may indicate whether access has been granted to time-frequency resource #1 included in the PUSCH resource pool 704. Similarly, the fourth bit of the bitmap 802 (e.g., bit #4) may map to time-frequency resource #4 of the UCI resource pool 702 and may also indicate whether access has been granted to time-frequency resource #1 included in the PUSCH resource pool 704. Additionally, the second bit of the bitmap 802 (e.g., bit #2) may map to time-frequency resource #2 of the UCI resource pool 702 and may indicate whether access has been granted to time-frequency resource #2 included in the PUSCH resource pool 704. Similarly, the fifth bit of the bitmap 802 (e.g., bit #5) may map to time-frequency resource #5 of the UCI resource pool 702 and may also indicate whether access has been granted to time-frequency resource #2 included in the PUSCH resource pool 704.

In the example of FIG. 7, the first UE 504 may transmit a first UCI in time-frequency resource #4 included in the UCI resource pool 702 requesting access to time-frequency resource #1 included in the PUSCH resource pool 704 to transmit a first data transmission. In some cases, the first UCI may implicitly request the access to time-frequency resource #1 included in the PUSCH resource pool 704 based on time-frequency resource #4 included in the UCI resource pool 702 (e.g., in which the first UCI is transmitted) being mapped to the time-frequency resource #1 included in the PUSCH resource pool 704 according to the multiple-to-one UCI-to-PUSCH resource mapping. In other words, due to the first UCI being transmitted in time-frequency resource #4 of the UCI resource pool 702 and because time-frequency resource #4 of the UCI resource pool 702 maps to time-frequency resource #1 of the PUSCH resource pool 704, the first UCI may indicate that the first UE 504 is implicitly requesting access to time-frequency resource #1 of the PUSCH resource pool 704.

As can be seen in FIG. 7, only the first UCI is transmitted within time-frequency resource #4 of the UCI resource pool 702 and, as such, the network entity 502 may not detect a collision associated with time-frequency resource #1 of the PUSCH resource pool 704 (e.g., multiple UEs are not requesting access to the same time-frequency resource in the PUSCH resource pool 704). As a result, the network entity 502 may decide to grant access to time-frequency resource #1 of the PUSCH resource pool 704 by setting a bit within the bitmap 802 to indicate that access to time-frequency resource #1 of the PUSCH resource pool 704 is granted. For example, as can be seen, bit #4 of the bitmap maps to time-frequency resource #4 included in the UCI resource pool 702 and may be set to a bit value of 1, indicating that the access to time-frequency resource #1 of the PUSCH resource pool 704 has been granted to the first UE 504.

Further, as can be seen in FIG. 7, the network entity 502 may receive, from the first UE 504, a second UCI in time-frequency resource #3 included in the UCI resource pool 702 requesting access to time-frequency resource #3 included in the PUSCH resource pool 704 to transmit a second data transmission. Additionally, as shown, the network entity 502 may receive, from the second UE 506, a third UCI in time-frequency resource #6 included in the UCI resource pool 702 also requesting access to time-frequency resource #3 included in the PUSCH resource pool 704 to transmit a third data transmission.

As can be seen, a collision may occur associated with time-frequency resource #3 of the PUSCH resource pool 704 since both of the second UCI from the first UE 504 and the third UCI from the second UE 506 are requesting access to time-frequency resource #3 of the PUSCH resource pool 704. In some cases, the network entity 502 may use the intermediate access control mechanism to avoid this collision by selecting one of the time-frequency resources included within the UCI resource pool 702 associated with the second UCI and the third UCI for granting access to time-frequency resource #3 included in the PUSCH resource pool 704. As an example, in response to receiving the second UCI and the third UCI, the network entity 502 may select time-frequency resource #6 included in the UCI resource pool 702 (e.g., in which the third UCI was transmitted by the second UE 506) for granting access to time-frequency resource #3 included in the PUSCH resource pool 704 to the second UE 506. In some cases, the network entity 502 may select time-frequency resource #6 included in the UCI resource pool 702 (e.g., and the second UE 506) based on an SNR of the third UCI and/or a payload size indicated in the third UCI for the third data transmission by the second UE 506.

Accordingly, in this example, as shown in FIG. 8, based on the selection, bit #6 of the bitmap 800, that maps to the time-frequency resource #6 included in the UCI resource pool 702, may be set to a bit value of 1, indicating that access to the time-frequency resource #3 included in the PUSCH resource pool 704 has been granted to the second UE 506 to transmit the third data transmission. In contrast, because the network entity 502 has selected the time-frequency resource #6 included in the UCI resource pool 702 and the second UE 506, bit #3 of the bitmap 800, that maps to the time-frequency resource #3 included in the UCI resource pool 702, may be set to a bit value of 0, indicating that the access to the time-frequency resource #3 included in the PUSCH resource pool 704 has not been granted to the first UE 504, thereby avoiding the collision associated with the first UE 504 and the second UE 506 in time-frequency resource #3 included in the PUSCH resource pool 704.

In response to receiving the indication that the access to the time-frequency resource #3 included in the PUSCH resource pool 704 has not been granted to the first UE 504, the first UE 504 may, in some cases, be configured to re-transmit the second UCI in time-frequency resource #3 of a future UCI resource pool requesting access to time-frequency resource #3 of a future PUSCH resource pool to transmit the second data transmission. In some cases, the first UE 504 may also be configured to perform this re-transmission using a power ramp (e.g., using an increased transmission power) relative to the original transmission of the second UCI within time-frequency resource #3 of the UCI resource pool 702.

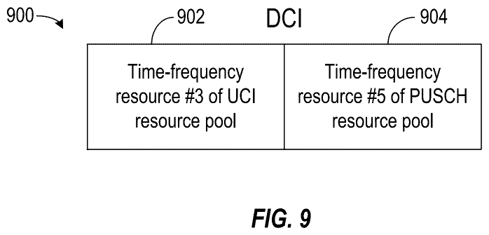

In some cases, because access to time-frequency resource #3 included in the PUSCH resource pool 704 was not granted to the first UE 504, the network entity 502 may be configured to optionally transmit downlink control information (DCI) as shown at 517 in FIG. 5, separate from the grant information transmitted at 516 in FIG. 5, that may allocate a different time-frequency resource included in the PUSCH resource pool 704 to the first UE 504. FIG. 9 illustrates an example DCI 900 that may be transmitted to the first UE 504 to allocate a different time-frequency resource included in the PUSCH resource pool 704. For example, as shown, the DCI 900 includes a first field 902 including an identifier that identifies time-frequency resource #3 included in the UCI resource pool 702 in which the second UCI was transmitted by the first UE 504.

Additionally, as shown, the DCI 900 includes a second field 904 indicating another time-frequency resource included in the PUSCH resource pool 704 that is allocated to the first UE 504 to transmit the second data transmission. For example, in some cases, the second field 904 may indicate that time-frequency resource #5 of the PUSCH resource pool 704 is allocated to the first UE 504 for transmitting the second data transmission. In some cases, because the first UE 504 knows that it transmitted the second UCI within time-frequency resource #3 of UCI resource pool 702, when the first UE 504 receives the indication of time-frequency resource #3 of UCI resource pool 702 within DCI 900, the first UE 504 may then implicitly determine that time-frequency resource #5 of the PUSCH resource pool 704 is being allocated to itself for transmitting the second data transmissions.

After transmitting the DCI 900 and the grant information including the bitmap 800, the network entity 502 may receive the one or more data transmissions from the first UE 504 and the second UE 506, as shown at 518 in FIG. 5. For example, in some cases, in response to receiving the grant information including the bitmap 800, the first UE 504 may be able to determine, from bit #4 of bitmap 800 that maps to time-frequency resource #4 of the UCI resource pool 702 in which the first UCI was transmitted by the first UE 504, that access to time-frequency resource #1 of the PUSCH resource pool 704 has been granted to the first UE 504. Thereafter, based on this determination, the first UE 504 may transmit, to the network entity 502 at 518 in FIG. 5, the first data transmission using time-frequency resource #1 of the PUSCH resource pool 704.

Similarly, in response to receiving the grant information including the bitmap 800, the second UE 506 may be able to determine, from bit #6 that maps time-frequency resource #6 of the UCI resource pool 702 in which the third UCI was transmitted by the second UE 506, that access to time-frequency resource #1 of the PUSCH resource pool 704 has been granted to the second UE 506. Thereafter, based on this determination, the second UE 506 may transmit, to the network entity 502 at 518 in FIG. 5, the third data transmission using time-frequency resource #3 of the PUSCH resource pool 704.

Further, in response to receiving DCI 900, the first UE 504 may be able to determine, based on the indication of time-frequency resource #3 of UCI resource pool 702 within DCI 900, that time-frequency resource #5 of the PUSCH resource pool 704 has been allocated to the first UE 504. Thereafter, based on this determination, the first UE 504 may transmit, to the network entity 502 at 518 in FIG. 5, the second data transmission using time-frequency resource #5 of the PUSCH resource pool 704.

In some cases, rather than including the bitmap 800 within the grant information transmitted at 516 in FIG. 5, the network entity 502 may instead include a list of identifiers within the grant information. For example, in some cases, each identifier in the list of identifiers may identify a different time-frequency resource included within the UCI resource pool 702 and may indicate whether access is granted to a time-frequency resource included in the PUSCH resource pool 704 that maps to that different time-frequency resource included within the UCI resource pool 702. In some cases, providing a list of identifiers may be beneficial if a quantity of the time-frequency resources of the UCI resource pool 702 is significantly higher than a quantity of UCIs that are successfully decoded within the UCI resource pool. In some cases, the identifiers included within the list of identifiers may include UCI time-frequency resource identifiers. In some cases, to reduce a number of bits needed to represent the list of identifiers in the grant information, the identifiers included within the list of identifiers may include a hash of a UCI time-frequency resource identifier.

In some cases, when using the list of identifiers to identify the different time-frequency resources included within the UCI resource pool 702, the first UE 504 and the second UE 506 may not be required to include UE identifier information within UCIs transmitted in time-frequency resources of the UCI resource pool. In some cases, this is because the first UE 504 and second UE 506 may know the time-frequency resources of the UCI resource pool 702 in which they transmitted UCIs. Accordingly the first UE 504 and the second UE 506 may monitor, within the list of identifiers of the grant information, for the identifiers of the time-frequency resources of the UCI resource pool 702 in which they transmitted UCIs. When the first UE 504 and the second UE 506 determine that the list of identifiers includes an identifier of a time-frequency resource of the UCI resource pool 702 in which they transmitted a UCI, the first UE 504 and the second UE 506 may then implicitly determine that they are being granted access to a time-frequency resource of the PUSCH resource pool 704 that corresponds with the identifier of the time-frequency resource of the UCI resource pool 702 included in the list of identifiers of the grant information.

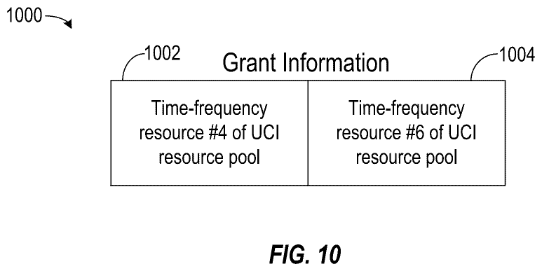

FIG. 10 illustrates an example list of identifiers 1000 that may be included within grant information to indicate whether access is granted to a time-frequency resource included in the PUSCH resource pool 704. For example, as shown, the list of identifiers 1000 may include an identifier 1002 that identifies time-frequency resource #4 of the UCI resource pool 702 in which the first UCI is received from the first UE 504 shown in FIG. 7.

Additionally, as discussed above with respect to FIG. 7, due to the collision associated with the second UCI transmitted by the first UE 504 within time-frequency resource #3 of the UCI resource pool 702 and the third UCI transmitted by the second UE 506 within time-frequency resource #6 of the UCI resource pool 702, the network entity 502 may select time-frequency resource #6 included in the UCI resource pool 702 (e.g., in which the third UCI was transmitted by the second UE 506) for granting access, to the second UE 506, to time-frequency resource #3 of the PUSCH resource pool 704. Accordingly, in some cases, based on the selection, the list of identifiers 1000 of FIG. 10 may include an identifier 1004 that identifies time-frequency resource #6 of the UCI resource pool 702 in which the third UCI is received from the second UE 506 as illustrated in FIG. 7. Further, as can be seen in FIG. 10, based on the selection by the network entity 502, the list of identifiers 1000 does not include an identifier that identifiers time-frequency resource #3 included within the UCI resource pool 702 in which the second UCI is received from the first UE 504.

After transmitting the grant information including the list of identifiers, the network entity 502 may receive the one or more data transmissions from the first UE 504 and the second UE 506. For example, in some cases, in response to receiving the grant information including the list of identifiers, the first UE 504 may be able to determine, from the identifier 1002 that identifies time-frequency resource #4 of the UCI resource pool 702 in which the first UCI was transmitted by the first UE 504, that access to time-frequency resource #1 of the PUSCH resource pool 704 has been granted to the first UE 504. Thereafter, based on this determination, the first UE 504 may transmit, to the network entity 502 at 518 in FIG. 5, the first data transmission using time-frequency resource #1 of the PUSCH resource pool 704.

Similarly, in response to receiving the grant information including the list of identifiers, the second UE 506 may be able to determine, from the identifier 1004 that identifies time-frequency resource #6 of the UCI resource pool 702 in which the third UCI was transmitted by the second UE 506, that access to time-frequency resource #3 of the PUSCH resource pool 704 has been granted to the second UE 506. Thereafter, based on this determination, the second UE 506 may transmit, to the network entity 502 at 518 in FIG. 5, the third data transmission using time-frequency resource #3 of the PUSCH resource pool 704.

Additionally, while the network entity 502 may not select time-frequency resource #3 included within the UCI resource pool 702 to grant access to time-frequency resource #3 included within the PUSCH resource pool 704 to the first UE 504, the network entity 502 may still optionally transmit a separate DCI that allocates another time-frequency resource of the PUSCH resource pool 704 to the first UE 504, such as time-frequency resource #5 of the PUSCH resource pool 704, for transmitting the second data transmission, as discussed above with respect to FIG. 9. In this case, the first UE 504 may then use time-frequency resource #5 of the PUSCH resource pool 704 to transmit the second data transmission to the network entity 502.

In some cases, rather than including a list of identifiers that identify different time-frequency resources included within the UCI resource pool 702, such as the list of identifiers 1000, the grant information transmitted by the network entity 502 at 516 in FIG. 5 may include a list of identifiers indicating which UEs are granted access to the time-frequency resources included within the PUSCH resource pool 704. In some cases, each of the identifiers included in the list of identifiers may be mapped to a particular time-frequency resource of the UCI resource pool, which may allow UEs to determine which UEs have been granted access to which time-frequency resources of the PUSCH resource pool 704, for example, based on the UCI-to-PUSCH resource mapping.

In some cases, the identifiers included within the list of identifiers may include UE identifiers (e.g., C-RNTI, I-RNTI, etc.). In some cases, to reduce a number of bits needed to represent the list of identifiers in the grant information, the identifiers included within the list of identifiers may include a hash of a UE identifier. In some cases, when using the list of identifiers that which UEs are granted access to the time-frequency resources included within the PUSCH resource pool 704, UCIs transmitted by the first UE 504 and the second UE 506 within the time-frequency resources of the UCI resource pool 702 may include UE identification information, such as a UE identifier (ID).

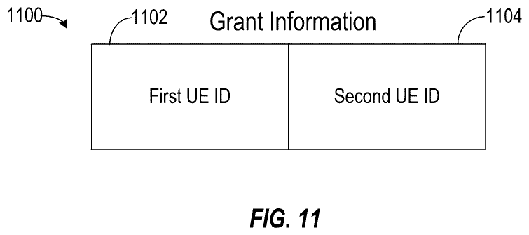

FIG. 11 illustrates an example list of identifiers 1100 that may be included within a grant information to indicate whether access is granted to a time-frequency resource included in the PUSCH resource pool 704. For example, as shown, the list of identifiers 1100 may include an identifier 1102 that identifies the first UE 504 and indicates that the access to time-frequency resource #1 of the PUSCH resource pool 704 has been granted to the first UE 504.

Additionally, as discussed above with respect to FIG. 7, due to the collision associated with the second UCI transmitted by the first UE 504 within time-frequency resource #3 of the UCI resource pool 702 and the third UCI transmitted by the second UE 506 within time-frequency resource #6 of the UCI resource pool 702, the network entity 502 may select time-frequency resource #6 included in the UCI resource pool 702 (e.g., in which the third UCI was transmitted by the second UE 506) for granting access, to the second UE 506, to time-frequency resource #3 of the PUSCH resource pool 704. Accordingly, in some cases, based on the selection, the list of identifiers 1100 of FIG. 11 may include an identifier 1104 that identifies the second UE 506 and indicates that access to time-frequency resource #6 included in the PUSCH resource pool 704 has been granted to the second UE 506 to transmit the third data transmission. Further, as can be seen in FIG. 11, based on the selection by the network entity 502, the list of identifiers 1100 does not include an identifier that identifies the first UE

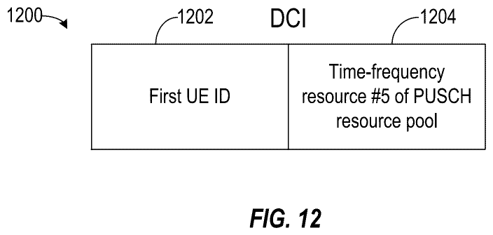

While the network entity 502 may not select time-frequency resource #3 included within the UCI resource pool 702 to grant access to time-frequency resource #3 of the PUSCH resource pool 704 to the first UE 504 to transmit the second data transmission, the network entity 502 may still optionally transmit a separate DCI that allocates another time-frequency resource of the PUSCH resource pool 704 to the first UE 504 for transmitting the second data transmission. For example, FIG. 12 illustrates a DCI 1200 that may be optionally transmitted by the network entity 502 at 517 in FIG. 5 to indicate another time-frequency resource of the PUSCH resource pool 704 allocated to the first UE 504 for transmitting the second data transmission. As shown, DCI 1200 includes a first field 1202 that includes the identifier that identifies the first UE 504 (e.g., first UE ID). Additionally, the DCI 1200 includes a second field 1204 that indicates time-frequency resource #5 of the PUSCH resource pool 704 that is allocated to the first UE 504 for transmitting the second data transmission.

After transmitting the grant information including the list of identifiers, the network entity 502 may receive the one or more data transmissions from the first UE 504 and the second UE 506. For example, in some cases, in response to receiving the grant information including the list of identifiers, the first UE 504 may be able to determine, from the identifier 1102 that identifies the first UE 504, that access to time-frequency resource #1 of the PUSCH resource pool 704 has been granted to the first UE 504. Thereafter, based on this determination, the first UE 504 may transmit, to the network entity 502 at 518 in FIG. 5, the first data transmission using time-frequency resource #1 of the PUSCH resource pool 704.

Similarly, in response to receiving the grant information including the list of identifiers, the second UE 506 may be able to determine, from the identifier 1104 that identifies the second UE 506, that access to time-frequency resource #3 of the PUSCH resource pool 704 has been granted to the second UE 506. Thereafter, based on this determination, the second UE 506 may transmit, to the network entity 502 at 518 in FIG. 5, the third data transmission using time-frequency resource #3 of the PUSCH resource pool 704.

Further, in response to receiving DCI 1200, the first UE 504 may be able to determine, based on the identifier that identifies the first UE 504 within the first field 1202 of DCI 1200, that time-frequency resource #5 of the PUSCH resource pool 704, indicated in the second field 1204 of DCI 1200, has been allocated to the first UE 504. Thereafter, based on this determination, the first UE 504 may transmit, to the network entity 502 at 518 in FIG. 5, the second data transmission using time-frequency resource #5 of the PUSCH resource pool 704.

In some cases, the list of identifiers indicating which UEs are granted access to the time-frequency resources included within the PUSCH resource pool 704 may be helpful in scenarios involving collision of multiple UCIs within one time-frequency resource of the UCI resource pool 702 where one of the colliding UCIs is successfully decoded by the network entity 502 due to that UCI having a higher signal strength (e.g., signal to noise ratio (SNR)).

For example, returning to FIG. 7, as can be seen, the first UE 504 may transmit a fourth UCI within time-frequency resource #7 of the UCI resource pool 702 requesting access to time-frequency resource #4 of the PUSCH resource pool 704 to transmit a fourth data transmission. Additionally, as can be seen, the second UE 506 may transmit a fifth UCI within time-frequency resource #7 of the UCI resource pool 702 also requesting access to time-frequency resource #4 of the PUSCH resource pool 704 to transmit a fifth data transmission. Accordingly, because the fourth UCI and the fifth UCI are both transmitted by the first UE 504 and the second UE 506 within time-frequency resource #7 of the UCI resource pool 702, the fourth UCI and fifth UCI may collide with each other.

In some cases, the fourth UCI may have a higher signal strength than the fifth UCI. As a result and due to the collision between the fourth UCI and the fifth UCI, the network entity 502 may only be able to successfully decode the fourth UCI transmitted by the first UE 504 since the signal strength of the fourth UCI is higher than the signal strength of the fifth UCI transmitted by the second UE 506. In such cases, the network entity 502 may be configured to select the first UE 504 and grant access to time-frequency resource #4 of the PUSCH resource pool 704 to the first UE 504 for transmitting the fourth data transmission, as shown in FIG. 7.

Additionally, despite the collision between the fourth UCI transmitted by the first UE 504 and the fifth UCI transmitted by the second UE 506 within time-frequency resource #7 of the UCI resource pool 702, the network entity 502 may be able to avoid collision between the fourth data transmission and the fifth data transmission by including, in the list of identifiers included the grant information transmitted at 516 in FIG. 5 an identifier that identifiers the first UE 504 and indicates that the access to time-frequency resource 4 of the PUSCH resource pool 704 has been granted to the first UE 504.

Accordingly, because the list of identifiers does not include an identifier that identifies the second UE 506 associated with time-frequency resource #4 of the PUSCH resource pool 704, the second UE 506 may understand that it has not been provided access to time-frequency resource #4 of the PUSCH resource pool 704. As a result, to avoid collision between data transmissions, the second UE 506 may refrain from transmitting the fifth data transmission in time-frequency resource #4 of the PUSCH resource pool 704, instead allowing the first UE 504 to transmit the fourth data transmission within time-frequency resource #4 of the PUSCH resource pool 704.

In some cases, the grant information may include a list of identifiers of the time-frequency resources of the UCI resource pool 702 (e.g., in which one or more UCIs have been transmitted) that correspond to time-frequency resources in the PUSCH resource pool 704 that have not been granted. In some cases, this list of identifiers may allow the first UE 504 and second UE 506 to determine which time-frequency resources of the PUSCH resource pool 704 have been granted based on the lack of an identifier of a corresponding time-frequency resources of the UCI resource pool 702. In other words, when a UE, such as the first UE 504 or the second UE 506, transmits a UCI within a time-frequency resource of the UCI resource pool 702 requesting access to a time-frequency resource of the PUSCH resource pool 704, the UE may know that access to the time-frequency resource of the PUSCH resource pool 704 has been granted to that UE for transmitting a data transmission when the list of identifiers does not include an identifier for the time-frequency resource of the UCI resource pool 702 in which the UCI was transmitted.

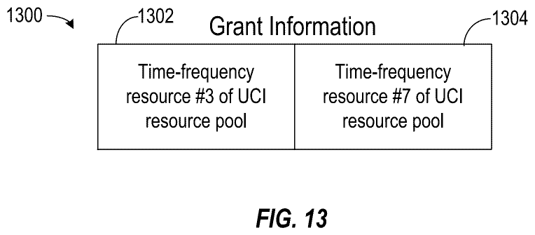

FIG. 13 illustrates an example list of identifiers 1300 that may be included within grant information to indicate that access to a time-frequency resource included in the PUSCH resource pool 704 has not been granted. For example, as discussed above with respect to FIG. 7, the first UE 504 may transmit a second UCI in time-frequency resource #3 of the UCI resource pool 702 requesting access to time-frequency resource #3 of the PUSCH resource pool 704 to transmit the second data transmission. Additionally, the second UE 506 may transmit a third UCI in time-frequency resource #6 of the UCI resource pool 702 also requesting access to time-frequency resource #3 of the PUSCH resource pool 704 to transmit the third data transmission. As a result, to avoid collision in time-frequency resource #3 of the PUSCH resource pool 704, the network entity 502 may select time-frequency resource #6 included in the UCI resource pool 702 (e.g., in which the third UCI was transmitted by the second UE 506) for granting access, to the second UE 506, to time-frequency resource #3 of the PUSCH resource pool 704.

In other words, the network entity 502 may not select time-frequency resource #3 included in the UCI resource pool 702 (e.g., in which the second UCI was transmitted by the first UE 504) for granting access, to the first UE 504. Accordingly, in this case, as illustrated in FIG. 13, the list of identifiers 1300 may include a first identifier 1302 that identifies time-frequency resource #3 of the UCI resource pool 702 in which the second UCI is received from the first UE 504 and indicates that time-frequency resource #3 of the PUSCH resource pool 704 has not been granted to the first UE 504 to transmit the second data transmission.

After transmitting the grant information including the list of identifiers, the network entity 502 may receive the one or more data transmissions from the first UE 504 and the second UE 506. For example, with reference to FIG. 7, in response to receiving the grant information including the list of identifiers 1300 of FIG. 13, the first UE 504 may be able to determine, based on a lack of an identifier in the grant information that identifies time-frequency resource #4 of the UCI resource pool 702 in which the first UCI was transmitted by the first UE 504, that access to time-frequency resource #1 of the PUSCH resource pool 704 has been granted to the first UE 504. Thereafter, based on this determination, the first UE 504 may transmit, to the network entity 502 at 518 in FIG. 5, the first data transmission using time-frequency resource #1 of the PUSCH resource pool 704.

Similarly, in response to receiving the grant information including the list of identifiers 1300, the second UE 506 may be able to determine, from a lack of an identifier that identifies time-frequency resource #6 of the UCI resource pool 702 in which the third UCI was transmitted by the second UE 506, that access to time-frequency resource #3 of the PUSCH resource pool 704 has been granted to the second UE 506. Thereafter, based on this determination, the second UE 506 may transmit, to the network entity 502 at 518 in FIG. 5, the third data transmission using time-frequency resource #3 of the PUSCH resource pool 704.

Additionally, while the network entity 502 may include the identifier of time-frequency resource #3 of the UCI resource pool 702 within the list of identifiers 1300 of the grant information to indicate that time-frequency resource #3 included within the PUSCH resource pool 704 has not been granted to the first UE 504, the network entity 502 may still optionally transmit a separate DCI that allocates another time-frequency resource of the PUSCH resource pool 704 to the first UE 504, such as time-frequency resource #5 of the PUSCH resource pool 704, for transmitting the second data transmission, as discussed above with respect to FIG. 9. In this case, the first UE 504 may then use time-frequency resource #5 of the PUSCH resource pool 704 to transmit the second data transmission to the network entity 502.

Further, as discussed above, the first UE 504 may transmit the fourth UCI within time-frequency resource #7 of the UCI resource pool 702 requesting access to time-frequency resource #4 of the PUSCH resource pool 704 to transmit the fourth data transmission. Additionally, the second UE 506 may transmit the fifth UCI within time-frequency resource #7 of the UCI resource pool 702 also requesting access to time-frequency resource #4 of the PUSCH resource pool 704 to transmit the fifth data transmission. Accordingly, because the fourth UCI and the fifth UCI are both transmitted by the first UE 504 and the second UE 506 within time-frequency resource #7 of the UCI resource pool 702, the fourth UCI and fifth UCI may collide with each other.

While the discussion above assumes that the fourth UCI may be successfully decoded by the network entity 502 based on the fourth UCI having a higher signal strength, in some cases, however, the collision between the fourth UCI and the fifth UCI may result in a significant amount of interference, which may cause the network entity 502 to fail to successfully decode both the fourth UCI or the fifth UCI. In this scenario, due to the failed decoding, the network entity 502 may not be able to explicitly determine that any UCI has been transmitted in time-frequency resource #7 of the UCI resource pool 702, which may cause the network entity 502 to fail to provide an indication regarding whether or not access to time-frequency resource #4 of the PUSCH resource pool 704 has been granted. In some cases, however, the network entity 502 may be able to implicitly determine that a UCI has been transmitted within time-frequency resource #7 of the UCI resource pool 702 based on demodulation reference signal (DMRS) signal detection within time-frequency resource #7 of the UCI resource pool 702.

For example, in some cases, the first UE 504 may also be configured to transmit a first DMRS within time-frequency resource #7 of the UCI resource pool 702 along with the fourth UCI. In some cases, the first DMRS may include a known sequence that may allow the network entity 502 to estimate a channel over which the fourth UCI is transmitted in order to assist the network entity 502 in decoding the fourth UCI. Similarly, the second UE 506 may also be configured to transmit a second DMRS within time-frequency resource #7 of the UCI resource pool 702 along with the fifth UCI. In some cases, the second DMRS may include a known sequence that may allow the network entity 502 to estimate a channel over which the fifth UCI is transmitted in order to assist the network entity 502 in decoding the fifth UCI.

In some cases, the network entity 502 may be able to detect at least one of the first DMRS or the second DMRS despite failing to decode both the fourth UCI received from the first UE 504 and the fifth UCI received from the second UE 506. Accordingly, based on the detection of at least one of the first DMRS or the second DMRS, the network entity 502 may be able to determine that a UCI has been transmitted within time-frequency resource #7 of the UCI resource pool 702 requesting access to time-frequency resource #4 of the PUSCH resource pool 704, even though the network entity 502 fails to actually decode the fourth UCI from the first UE 504 and the fifth UCI from the second UE 506.

In this case, because the network entity 502 fails to successfully decode both the fourth UCI from the first UE 504 and the fifth UCI from the second UE 506, access to time-frequency resource #4 of the PUSCH resource pool 704 may not be granted to either the first UE 504 or the second UE 506. As a result, the list of identifiers 1300 of FIG. 13 may include an identifier identifying the time-frequency resource #7 included in the UCI resource pool 702, indicating that access to the time-frequency resource #4 included in the PUSCH resource pool 704 has not been granted to either the first UE 504 or the second UE 506. In some cases, in response, the first UE 504 and second UE 506 may each be configured to select another time-frequency resource within a future UCI resource pool to transmit the fourth UCI and the fifth UCI to request access to a different time-frequency resource of a further PUSCH resource pool for transmitting the fourth data transmission and the fifth data transmission, respectively.

As can be seen from the techniques describe above, the intermediate access control mechanism may be useful to avoid collisions within the PUSCH resource pool, albeit at a cost of higher latency in some cases. In some cases, when traffic between the network entity 502 and the one or more UEs, including the first UE 504 and the second UE 506, is very low, chances of collisions within the PUSCH resource pool may also be low. In this case, the intermediate access control mechanism may not be necessary as it may unnecessarily increase latency. As such, in some cases, the network entity 502 may be configured to transmit access control configuration information that dynamically enables/disables the intermediate access control mechanism and configured the one or more UEs to either transmit or not transmit UCI prior to transmitting data transmissions. In some cases, the access control configuration information may be transmitted in a GC-PDCCH.

For example, returning to FIG. 5, in some cases, as shown at 509, the network entity 502 may optionally transmit, to the first UE 504, access control configuration information enabling the intermediate access control mechanism and configuring the first UE 504 to transmit UCI prior to transmitting data transmissions, such as the first UCI prior to the first data transmission, the second UCI prior to the second data transmission, and so on.

In some cases, such as when traffic between the network entity 502 and the one or more UEs is below a threshold, the network entity 502 may optionally transmit additional access control configuration information to the first UE 504 and the second UE 506 disabling the intermediate access control mechanism, as shown at 520 in FIG. 5. The additional access control configuration information may also configure the first UE 504 to transmit data transmission to the network entity 502 without transmitting UCI associated with these data transmissions. For example, in some cases, the additional access control configuration information may cause the first UE 504 to transmit a sixth data transmission in a time-frequency resource included in the PUSCH resource pool without first transmitting a sixth UCI to request access to the time-frequency resource included in the PUSCH resource pool to transmit the sixth data transmission.

### Example Operations

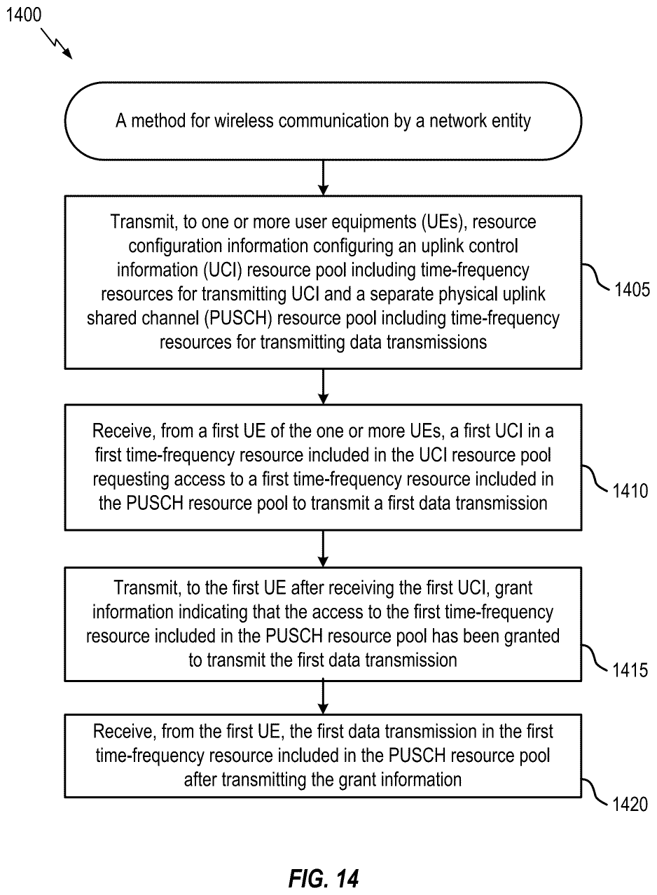

FIG. 14 shows an example of a method 1400 of wireless communication by a network entity, such as a BS 102 of FIGS. 1 and 3, or a disaggregated base station as discussed with respect to FIG. 2.

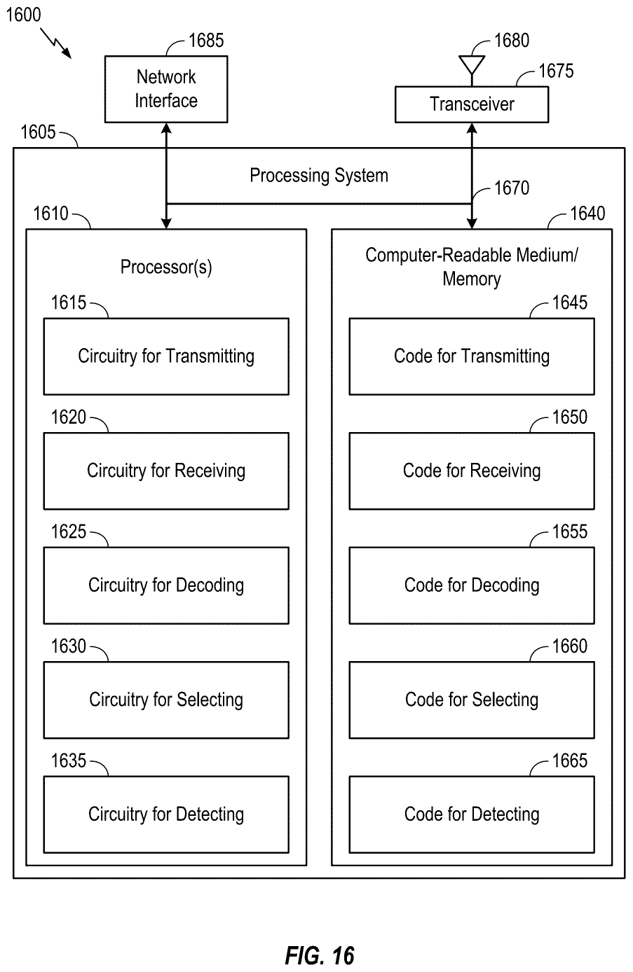

Method 1400 begins at step 1405 with transmitting, to one or more user equipments (UEs), resource configuration information configuring an uplink control information (UCI) resource pool including time-frequency resources for transmitting UCI and a separate physical uplink shared channel (PUSCH) resource pool including time-frequency resources for transmitting data transmissions. In some cases, the time-frequency resources included in the UCI resource pool are mapped to the time-frequency resources included in the PUSCH resource pool based on a UCI-to-PUSCH resource mapping. In some cases, the operations of this step refer to, or may be performed by, circuitry for transmitting and/or code for transmitting as described with reference to FIG. 16.

Method 1400 then proceeds to step 1410 with receiving, from a first UE of the one or more UEs, a first UCI in a first time-frequency resource included in the UCI resource pool requesting access to a first time-frequency resource included in the PUSCH resource pool to transmit a first data transmission. In some cases, the first UCI implicitly requests the access to the first time-frequency resource included in the PUSCH resource pool based on the first time-frequency resource included in the UCI resource pool being mapped to the first time-frequency resource included in the PUSCH resource pool according to the UCI-to-PUSCH resource mapping. In some cases, the operations of this step refer to, or may be performed by, circuitry for receiving and/or code for receiving as described with reference to FIG. 16.

Method 1400 then proceeds to step 1415 with transmitting, to the first UE after receiving the first UCI, grant information indicating that the access to the first time-frequency resource included in the PUSCH resource pool has been granted to transmit the first data transmission. In some cases, the operations of this step refer to, or may be performed by, circuitry for transmitting and/or code for transmitting as described with reference to FIG. 16.

Method 1400 then proceeds to step 1420 with receiving, from the first UE, the first data transmission in the first time-frequency resource included in the PUSCH resource pool after transmitting the grant information. In some cases, the operations of this step refer to, or may be performed by, circuitry for receiving and/or code for receiving as described with reference to FIG. 16.

In some aspects, the first UCI is transmitted using one of a physical uplink control channel (PUCCH) waveform or a PUSCH waveform.

In some aspects, the first UCI includes cyclic redundancy check (CRC) information for independent decoding of the first UCI.

In some aspects, the first UCI includes one or more transmission parameters requested for the first data transmission; and the one or more transmission parameters include at least one of a modulation and coding scheme (MCS) or a payload size.

In some aspects, the first UCI includes identification information that uniquely identifies the first UCI.

In some aspects, the identification information comprises at least one of: a cell radio network temporary identifier (C-RNTI); an initial radio network temporary identifier (I-RNTI); an identifier that is shorter than a radio network temporary identifier; or a UCI identifier.

In some aspects, the UCI-to-PUSCH resource mapping comprises a one-to-one resource mapping in which one time-frequency resource included in the UCI resource pool maps to one time-frequency resource included in the PUSCH resource pool.

In some aspects, a total quantity of the time-frequency resources included in the UCI resource pool is equal to a total quantity of the time-frequency resources included in the PUSCH resource pool.

In some aspects, the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

In some aspects, the bitmap includes at least a first bit that maps to the first time-frequency resource included in the UCI resource pool and indicates that the access to the first time-frequency resource included in the PUSCH resource pool has been granted to the first UE.

In some aspects, the method 1400 further includes receiving, from the first UE of the one or more UEs, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for receiving and/or code for receiving as described with reference to FIG. 16.

In some aspects, the method 1400 further includes receiving, from a second UE of the one or more UEs, a third UCI in the second time-frequency resource included in the UCI resource pool requesting access to the second time-frequency resource included in the PUSCH resource pool to transmit a third data transmission. In some cases, the operations of this step refer to, or may be performed by, circuitry for receiving and/or code for receiving as described with reference to FIG. 16.

In some aspects, the second UCI from the first UE and the third UCI from the second UE collide in the second time-frequency resource included in the UCI resource pool.

In some aspects, the method 1400 further includes failing to decode both the second UCI and the third UCI based on the second UCI and the third UCI colliding in the second time-frequency resource included in the UCI resource pool. In some cases, the operations of this step refer to, or may be performed by, circuitry for decoding and/or code for decoding as described with reference to FIG. 16.

In some aspects, based on the failing to decode both the second UCI and the third UCI, the bitmap includes at least a second bit that maps to the second time-frequency resource included in the UCI resource pool and indicates that access to the second time-frequency resource included in the PUSCH resource pool has not been granted to the first UE or the second UE.

In some aspects, the method 1400 further includes successfully decoding one of the second UCI or the third UCI despite the second UCI and the third UCI colliding in the second time-frequency resource included in the UCI resource pool. In some cases, the operations of this step refer to, or may be performed by, circuitry for decoding and/or code for decoding as described with reference to FIG. 16.

In some aspects, based on successfully decoding one of the second UCI or the third UCI, the bitmap includes at least a second bit that maps to the second time-frequency resource included in the UCI resource pool and indicates that access to the second time-frequency resource included in the PUSCH resource pool has been granted.

In some aspects, the method 1400 further includes receiving the second data transmission in the second time-frequency resource included in the PUSCH resource pool based on the second bit included in the bitmap. In some cases, the operations of this step refer to, or may be performed by, circuitry for receiving and/or code for receiving as described with reference to FIG. 16.

In some aspects, the method 1400 further includes, based on the second bit indicating that the access to the second time-frequency resource included in the PUSCH resource pool has been granted, receiving: the second data transmission in the second time-frequency resource included in the PUSCH resource pool from the first UE the third data transmission in the second time-frequency resource included in the PUSCH resource pool from the second UE. In some cases, the operations of this step refer to, or may be performed by, circuitry for receiving and/or code for receiving as described with reference to FIG. 16.

In some aspects, the method 1400 further includes successfully decoding one of the second data transmission from the first UE or the third data transmission from the second UE according to whichever of the second data transmission or the third data transmission has a higher signal strength. In some cases, the operations of this step refer to, or may be performed by, circuitry for decoding and/or code for decoding as described with reference to FIG. 16.

In some aspects, the UCI-to-PUSCH resource mapping comprises a multiple-to-one resource mapping in which multiple different time-frequency resources included in the UCI resource pool map to one time-frequency resource included in the PUSCH resource pool.

In some aspects, a total quantity of the time-frequency resources included in the UCI resource pool is greater than a total quantity of the time-frequency resources included in the PUSCH resource pool.

In some aspects, the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

In some aspects, the bitmap includes at least a first bit that maps to the first time-frequency resource included in the UCI resource pool and indicates that the access to the first time-frequency resource included in the PUSCH resource pool has been granted to the first UE.

In some aspects, the method 1400 further includes receiving, from the first UE of the one or more UEs, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for receiving and/or code for receiving as described with reference to FIG. 16.

In some aspects, the method 1400 further includes receiving, from a second UE of the one or more UEs, a third UCI in a third time-frequency resource included in the UCI resource pool requesting access to the second time-frequency resource included in the PUSCH resource pool to transmit a third data transmission. In some cases, the operations of this step refer to, or may be performed by, circuitry for receiving and/or code for receiving as described with reference to FIG. 16.

In some aspects, the method 1400 further includes, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission. In some cases, the operations of this step refer to, or may be performed by, circuitry for selecting and/or code for selecting as described with reference to FIG. 16.

In some aspects,, based on the selection, the bitmap includes at least: a first bit that maps to the second time-frequency resource included in the UCI resource pool and indicates that the access to the second time-frequency resource included in the PUSCH resource pool has not been granted to the first UE; and a second bit that maps to the third time-frequency resource included in the UCI resource pool and indicates that the access to the second time-frequency resource included in the PUSCH resource pool has been granted to the second UE.

In some aspects, the method 1400 further includes transmitting downlink control information (DCI), separate from the grant information, which includes: an identifier that identifies the second time-frequency resource included in the UCI resource pool in which the second UCI was received from the first UE a third time-frequency resource included in the PUSCH resource pool that is allocated to the first UE to transmit the second data transmission. In some cases, the operations of this step refer to, or may be performed by, circuitry for transmitting and/or code for transmitting as described with reference to FIG. 16.

In some aspects, the method 1400 further includes receiving the second data transmission using the third time-frequency resource included in the PUSCH resource pool. In some cases, the operations of this step refer to, or may be performed by, circuitry for receiving and/or code for receiving as described with reference to FIG. 16.

In some aspects, the grant information comprises a group common physical downlink control channel (GC-PDCCH) that includes a list of identifiers; and each identifier in the list of identifiers identifies a different time-frequency resource included within the UCI resource pool and indicates whether access is granted to a time-frequency resource included in the PUSCH resource pool that maps to that different time-frequency resource included within the UCI resource pool.

In some aspects, the list of identifiers includes at least a first identifier that identifies the first time-frequency resource included within the UCI resource pool in which the first UCI is received from the first UE.

In some aspects, the first identifier comprises one of: a UCI time-frequency resource identifier; or a hash of a UCI time-frequency resource identifier.

In some aspects, the method 1400 further includes receiving, from the first UE of the one or more UEs, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for receiving and/or code for receiving as described with reference to FIG. 16.

In some aspects, the method 1400 further includes receiving, from a second UE of the one or more UEs, a third UCI in a third time-frequency resource included in the UCI resource pool requesting access to the second time-frequency resource included in the PUSCH resource pool to transmit a third data transmission. In some cases, the operations of this step refer to, or may be performed by, circuitry for receiving and/or code for receiving as described with reference to FIG. 16.

In some aspects, the method 1400 further includes, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission. In some cases, the operations of this step refer to, or may be performed by, circuitry for selecting and/or code for selecting as described with reference to FIG. 16.

In some aspects, based on the selection: the list of identifiers includes at least a first identifier that identifies the third time-frequency resource included within the UCI resource pool in which the third UCI is received from the second UE; and the list of identifiers does not include a second identifier that identifiers the second time-frequency resource included within the UCI resource pool in which the second UCI is received from the first UE.

In some aspects, the method 1400 further includes transmitting downlink control information (DCI), separate from the grant information, which includes: an identifier that identifies the second time-frequency resource included in the UCI resource pool in which the second UCI was received from the first UE a third time-frequency resource included in the PUSCH resource pool that is allocated to the first UE to transmit the second data transmission. In some cases, the operations of this step refer to, or may be performed by, circuitry for transmitting and/or code for transmitting as described with reference to FIG. 16.

In some aspects, the method 1400 further includes receiving the second data transmission using the third time-frequency resource included in the PUSCH resource pool. In some cases, the operations of this step refer to, or may be performed by, circuitry for receiving and/or code for receiving as described with reference to FIG. 16.

In some aspects, the grant information comprises a group common physical downlink control channel (GC-PDCCH) that includes a list of identifiers indicating which UEs of the one or more UEs are granted access to the time-frequency resources included within the PUSCH resource pool.

In some aspects, the list of identifiers includes at least a first identifier identifying the first UE and indicating that the access to the first time-frequency resource included in the PUSCH resource pool has been granted to the first UE.

In some aspects, the first identifier comprises one of: a UE identifier; or a hash of a UE identifier.

In some aspects, the method 1400 further includes receiving, from the first UE of the one or more UEs, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for receiving and/or code for receiving as described with reference to FIG. 16.

In some aspects, the method 1400 further includes receiving, from a second UE of the one or more UEs, a third UCI in a third time-frequency resource included in the UCI resource pool requesting access to the second time-frequency resource included in the PUSCH resource pool to transmit a third data transmission. In some cases, the operations of this step refer to, or may be performed by, circuitry for receiving and/or code for receiving as described with reference to FIG. 16.

In some aspects, the method 1400 further includes, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission. In some cases, the operations of this step refer to, or may be performed by, circuitry for selecting and/or code for selecting as described with reference to FIG. 16.

In some aspects,, based on the selection: the list of identifiers includes at least a first identifier identifying the second UE and indicating that access to the second time-frequency resource included in the PUSCH resource pool has been granted to the second UE; and the list of identifiers does not include a second identifier that identifies the first UE.

In some aspects, the method 1400 further includes transmitting downlink control information (DCI), separate from the grant information, which includes: the second identifier that identifies the first UE a third time-frequency resource included in the PUSCH resource pool that is allocated to the first UE to transmit the second data transmission. In some cases, the operations of this step refer to, or may be performed by, circuitry for transmitting and/or code for transmitting as described with reference to FIG. 16.

In some aspects, the method 1400 further includes receiving the second data transmission using the third time-frequency resource included in the PUSCH resource pool. In some cases, the operations of this step refer to, or may be performed by, circuitry for receiving and/or code for receiving as described with reference to FIG. 16.

In some aspects, the grant information comprises a list of identifiers of the time-frequency resources of the UCI resource pool that indicate which time-frequency resources included in the PUSCH resource pool have not been granted access to.

In some aspects, the list of identifiers lacks an identifier of the first time-frequency resource included in the UCI resource pool; and the lack of the identifier of the first time-frequency resource included in the UCI resource pool indicates that the access to the first time-frequency resource included in the PUSCH resource pool has been granted to transmit the first data transmission.

In some aspects, the method 1400 further includes receiving, from the first UE of the one or more UEs, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for receiving and/or code for receiving as described with reference to FIG. 16.

In some aspects, the method 1400 further includes receiving, from a second UE of the one or more UEs, a third UCI in the second time-frequency resource included in the UCI resource pool requesting access to the second time-frequency resource included in the PUSCH resource pool to transmit a third data transmission. In some cases, the operations of this step refer to, or may be performed by, circuitry for receiving and/or code for receiving as described with reference to FIG. 16.

In some aspects, the second UCI received from the first UE and the third UCI received from the second UE collide in the second time-frequency resource included in the UCI resource pool.

In some aspects, the method 1400 further includes failing to decode both the second UCI and the third UCI based on the second UCI and the third UCI colliding in the second time-frequency resource included in the UCI resource pool. In some cases, the operations of this step refer to, or may be performed by, circuitry for decoding and/or code for decoding as described with reference to FIG. 16.

In some aspects, the method 1400 further includes detecting at least one demodulation reference signal (DMRS) signal in the second time-frequency resource included in the UCI resource pool associated with one of the second UCI received from the first UE or the third UCI received from the second UE. In some cases, the operations of this step refer to, or may be performed by, circuitry for detecting and/or code for detecting as described with reference to FIG. 16.

In some aspects, the at least one DMRS signal is detected despite failing to decode both the second UCI received from the first UE and the third UCI received from the second UE.

In some aspects,, based on detecting the at least one DMRS signal in the second time-frequency resource included in the UCI resource pool, the list of identifiers includes an identifier identifying the second time-frequency resource included in the UCI resource pool.

In some aspects, the identifier identifying the second time-frequency resource included in the UCI resource pool further indicates that access to the second time-frequency resource included in the PUSCH resource pool has not been granted.

In some aspects, the method 1400 further includes receiving, from the first UE of the one or more UEs, a second UCI in a second time-frequency resource included in the UCI resource pool requesting access to a second time-frequency resource included in the PUSCH resource pool to transmit a second data transmission receiving, from a second UE of the one or more UEs, a third UCI in a third time-frequency resource included in the UCI resource pool requesting access to the second time-frequency resource included in the PUSCH resource pool to transmit a third data transmission. In some cases, the operations of this step refer to, or may be performed by, circuitry for receiving and/or code for receiving as described with reference to FIG. 16.

In some aspects, the method 1400 further includes, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission. In some cases, the operations of this step refer to, or may be performed by, circuitry for selecting and/or code for selecting as described with reference to FIG. 16.

In some aspects, based on the selection, the grant information includes an identifier identifying the second time-frequency resource included in the UCI resource pool.

In some aspects, the identifier identifying the second time-frequency resource included in the UCI resource pool further indicates that access to the second time-frequency resource included in the PUSCH resource pool has not been granted to the first UE to transmit the second data transmission.

In some aspects, the method 1400 further includes transmitting downlink control information (DCI), separate from the grant information, which includes: an identifier that identifies the second time-frequency resource included in the UCI resource pool in which the second UCI was received from the first UE a third time-frequency resource included in the PUSCH resource pool that is allocated to the first UE to transmit the second data transmission. In some cases, the operations of this step refer to, or may be performed by, circuitry for transmitting and/or code for transmitting as described with reference to FIG. 16.

In some aspects, the method 1400 further includes receiving the second data transmission using the third time-frequency resource included in the PUSCH resource pool. In some cases, the operations of this step refer to, or may be performed by, circuitry for receiving and/or code for receiving as described with reference to FIG. 16.

In some aspects, the method 1400 further includes transmitting, to the first UE, access control configuration information enabling an intermediate access control mechanism and configuring the first UE to transmit the first UCI prior to transmitting the first data transmission. In some cases, the operations of this step refer to, or may be performed by, circuitry for transmitting and/or code for transmitting as described with reference to FIG. 16.

In some aspects, the method 1400 further includes transmitting, to the first UE, additional access control configuration information disabling the intermediate access control mechanism and configuring the first UE to transmit a second data transmission in a second time-frequency resource included in the PUSCH resource pool without first transmitting a second UCI to request access to the second time-frequency resource included in the PUSCH resource pool to transmit the second data transmission. In some cases, the operations of this step refer to, or may be performed by, circuitry for transmitting and/or code for transmitting as described with reference to FIG. 16.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

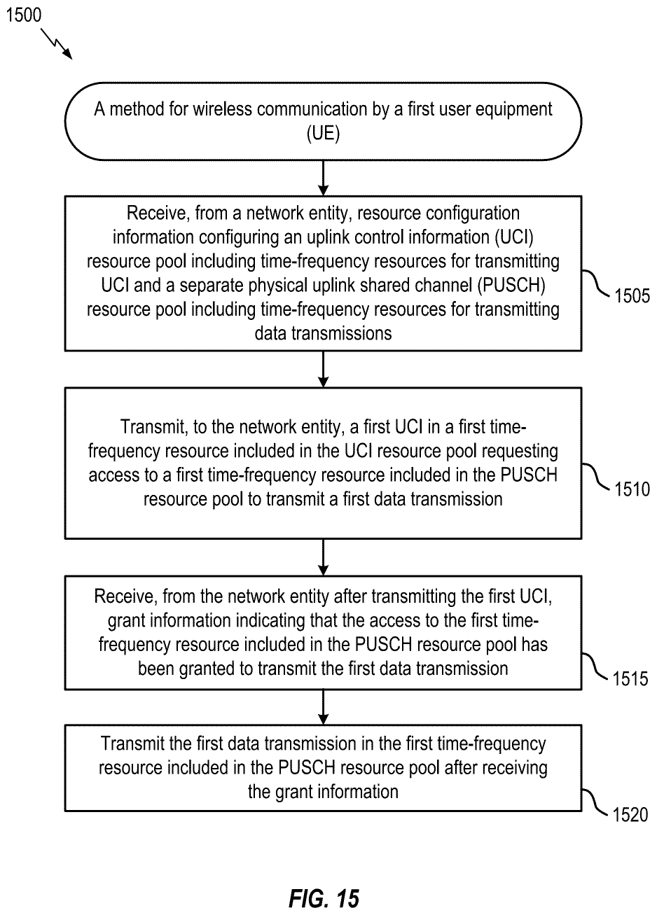

FIG. 15 shows an example of a method 1500 of wireless communication by a first user equipment (UE), such as a UE 104 of FIGS. 1 and 3.

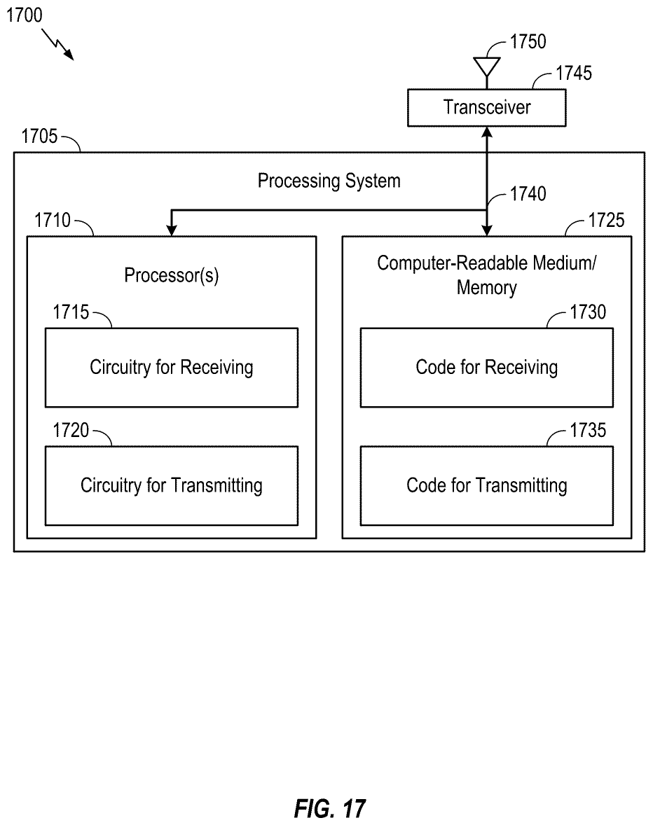

Method 1500 begins at step 1505 with receiving, from a network entity, resource configuration information configuring an uplink control information (UCI) resource pool including time-frequency resources for transmitting UCI and a separate physical uplink shared channel (PUSCH) resource pool including time-frequency resources for transmitting data transmissions. In some cases, the time-frequency resources included in the UCI resource pool are mapped to the time-frequency resources included in the PUSCH resource pool based on a UCI-to-PUSCH resource mapping. In some cases, the operations of this step refer to, or may be performed by, circuitry for receiving and/or code for receiving as described with reference to FIG. 17.

Method 1500 then proceeds to step 1510 with transmitting, to the network entity, a first UCI in a first time-frequency resource included in the UCI resource pool requesting access to a first time-frequency resource included in the PUSCH resource pool to transmit a first data transmission. In some cases, the first UCI implicitly requests the access to the first time-frequency resource included in the PUSCH resource pool based on the first time-frequency resource included in the UCI resource pool being mapped to the first time-frequency resource included in the PUSCH resource pool according to the UCI-to-PUSCH resource mapping. In some cases, the operations of this step refer to, or may be performed by, circuitry for transmitting and/or code for transmitting as described with reference to FIG. 17.

Method 1500 then proceeds to step 1515 with receiving, from the network entity after transmitting the first UCI, grant information indicating that the access to the first time-frequency resource included in the PUSCH resource pool has been granted to transmit the first data transmission. In some cases, the operations of this step refer to, or may be performed by, circuitry for receiving and/or code for receiving as described with reference to FIG. 17.

Method 1500 then proceeds to step 1520 with transmitting the first data transmission in the first time-frequency resource included in the PUSCH resource pool after receiving the grant information. In some cases, the operations of this step refer to, or may be performed by, circuitry for transmitting and/or code for transmitting as described with reference to FIG. 17.

In some aspects, the first UCI is transmitted using one of a physical uplink control channel (PUCCH) waveform or a PUSCH waveform.

In some aspects, the first UCI includes cyclic redundancy check (CRC) information for independent decoding of the first UCI.

In some aspects, the first UCI includes one or more transmission parameters requested for the first data transmission; and the one or more transmission parameters include at least one of a modulation and coding scheme (MCS) or a payload size.

In some aspects, the first UCI includes identification information that uniquely identifies the first UCI.

In some aspects, the identification information comprises at least one of: a cell radio network temporary identifier (C-RNTI); an initial radio network temporary identifier (I-RNTI); an identifier that is shorter than a radio network temporary identifier; or a UCI identifier.

In some aspects, the UCI-to-PUSCH resource mapping comprises a one-to-one resource mapping in which one time-frequency resource included in the UCI resource pool maps to one time-frequency resource included in the PUSCH resource pool.

In some aspects, a total quantity of the time-frequency resources included in the UCI resource pool is equal to a total quantity of the time-frequency resources included in the PUSCH resource pool.

In some aspects, the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

In some aspects, the bitmap includes at least a first bit that maps to the first time-frequency resource included in the UCI resource pool and indicates that the access to the first time-frequency resource included in the PUSCH resource pool has been granted to the first UE.

In some aspects, the method 1500 further includes transmitting, to the network entity, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for transmitting and/or code for transmitting as described with reference to FIG. 17.

In some aspects, the second UCI transmitted in the second time-frequency resource included in the UCI resource pool collides with a third UCI transmitted by a second UE in the second time-frequency resource included in the UCI resource pool.

In some aspects, based on the second UCI and the third UCI colliding in the second time-frequency resource included in the UCI resource pool, the bitmap includes at least a second bit that maps to the second time-frequency resource included in the UCI resource pool and indicates that access to the second time-frequency resource included in the PUSCH resource pool has not been granted to the first UE or the second UE.

In some aspects, despite the second UCI and the third UCI colliding in the second time-frequency resource included in the UCI resource pool, the bitmap includes at least a second bit that maps to the second time-frequency resource included in the UCI resource pool and indicates that access to the second time-frequency resource included in the PUSCH resource pool has been granted.

In some aspects, the method 1500 further includes transmitting the second data transmission in the second time-frequency resource included in the PUSCH resource pool based on the second bit included in the bitmap. In some cases, the operations of this step refer to, or may be performed by, circuitry for transmitting and/or code for transmitting as described with reference to FIG. 17.

In some aspects, the UCI-to-PUSCH resource mapping comprises a multiple-to-one resource mapping in which multiple different time-frequency resources included in the UCI resource pool map to one time-frequency resource included in the PUSCH resource pool.

In some aspects, a total quantity of the time-frequency resources included in the UCI resource pool is greater than a total quantity of the time-frequency resources included in the PUSCH resource pool.

In some aspects, the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

In some aspects, the bitmap includes at least a first bit that maps to the first time-frequency resource included in the UCI resource pool and indicates that the access to the first time-frequency resource included in the PUSCH resource pool has been granted to the first UE.

In some aspects, the method 1500 further includes transmitting, to the network entity, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for transmitting and/or code for transmitting as described with reference to FIG. 17.

In some aspects, the bitmap includes at least: a first bit that maps to the second time-frequency resource included in the UCI resource pool and indicates that the access to the second time-frequency resource included in the PUSCH resource pool has not been granted to the first UE; and a second bit that maps to a third time-frequency resource included in the UCI resource pool and indicates that the access to the second time-frequency resource included in the PUSCH resource pool has been granted to a second UE.

In some aspects, the method 1500 further includes receiving downlink control information (DCI), separate from the grant information, which includes: an identifier that identifies the second time-frequency resource included in the UCI resource pool in which the second UCI was transmitted by the first UE a third time-frequency resource included in the PUSCH resource pool that is allocated to the first UE to transmit the second data transmission. In some cases, the operations of this step refer to, or may be performed by, circuitry for receiving and/or code for receiving as described with reference to FIG. 17.

In some aspects, the method 1500 further includes transmitting the second data transmission using the third time-frequency resource included in the PUSCH resource pool. In some cases, the operations of this step refer to, or may be performed by, circuitry for transmitting and/or code for transmitting as described with reference to FIG. 17.

In some aspects, the grant information comprises a group common physical downlink control channel (GC-PDCCH) that includes a list of identifiers; and each identifier in the list of identifiers identifies a different time-frequency resource included within the UCI resource pool and indicates whether access is granted to a time-frequency resource included in the PUSCH resource pool that maps to that different time-frequency resource included within the UCI resource pool.

In some aspects, the list of identifiers includes at least a first identifier that identifies the first time-frequency resource included within the UCI resource pool in which the first UCI was transmitted by the first UE.

In some aspects, the first identifier comprises one of: a UCI time-frequency resource identifier; or a hash of a UCI time-frequency resource identifier.

In some aspects, the method 1500 further includes transmitting, to the network entity, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for transmitting and/or code for transmitting as described with reference to FIG. 17.

In some aspects, the list of identifiers includes at least a first identifier that identifies a third time-frequency resource included within the UCI resource pool in which a third UCI, associated with a second UE, was transmitted that requested access to the second time-frequency resource included in the PUSCH resource pool to transmit a third data transmission; and the list of identifiers does not include a second identifier that identifiers the second time-frequency resource included within the UCI resource pool in which the second UCI is received from the first UE.

In some aspects, the method 1500 further includes receiving downlink control information (DCI), separate from the grant information, which includes: an identifier that identifies the second time-frequency resource included in the UCI resource pool in which the second UCI was transmitted by the first UE a third time-frequency resource included in the PUSCH resource pool that is allocated to the first UE to transmit the second data transmission. In some cases, the operations of this step refer to, or may be performed by, circuitry for receiving and/or code for receiving as described with reference to FIG. 17.

In some aspects, the method 1500 further includes transmitting the second data transmission using the third time-frequency resource included in the PUSCH resource pool. In some cases, the operations of this step refer to, or may be performed by, circuitry for transmitting and/or code for transmitting as described with reference to FIG. 17.

In some aspects, the grant information comprises a group common physical downlink control channel (GC-PDCCH) that includes a list of identifiers indicating which UEs of the one or more UEs are granted access to the time-frequency resources included within the PUSCH resource pool.

In some aspects, the list of identifiers includes at least a first identifier identifying the first UE and indicating that the access to the first time-frequency resource included in the PUSCH resource pool has been granted to the first UE.

In some aspects, the first identifier comprises one of: a UE identifier; or a hash of a UE identifier.

In some aspects, the method 1500 further includes transmitting, to the network entity, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for transmitting and/or code for transmitting as described with reference to FIG. 17.

In some aspects, the list of identifiers includes at least a first identifier identifying a second UE and indicating that access to the second time-frequency resource included in the PUSCH resource pool has been granted to the second UE; and the list of identifiers does not include a second identifier that identifies the first UE.

In some aspects, the method 1500 further includes receiving downlink control information (DCI), separate from the grant information, which includes: the second identifier that identifies the first UE a third time-frequency resource included in the PUSCH resource pool that is allocated to the first UE to transmit the second data transmission. In some cases, the operations of this step refer to, or may be performed by, circuitry for receiving and/or code for receiving as described with reference to FIG. 17.

In some aspects, the method 1500 further includes transmitting the second data transmission using the third time-frequency resource included in the PUSCH resource pool. In some cases, the operations of this step refer to, or may be performed by, circuitry for transmitting and/or code for transmitting as described with reference to FIG. 17.

In some aspects, the grant information comprises a list of identifiers of the time-frequency resources of the UCI resource pool that indicate which time-frequency resources included in the PUSCH resource pool have not been granted access to.

In some aspects, the list of identifiers lacks an identifier of the first time-frequency resource included in the UCI resource pool; and the lack of the identifier of the first time-frequency resource included in the UCI resource pool indicates that the access to the first time-frequency resource included in the PUSCH resource pool has been granted to transmit the first data transmission.

In some aspects, the method 1500 further includes transmitting, to the network entity, a second UCI in a second time-frequency resource included in the UCI resource pool requesting access to a second time-frequency resource included in the PUSCH resource pool to transmit a second data transmission. In some cases, the operations of this step refer to, or may be performed by, circuitry for transmitting and/or code for transmitting as described with reference to FIG. 17.

In some aspects, the second UCI transmitted in the second time-frequency resource included in the UCI resource pool collides with a third UCI transmitted by a second UE in the second time-frequency resource included in the UCI resource pool.

In some aspects, the method 1500 further includes transmitting a demodulation reference signal (DMRS) signal in the second time-frequency resource included in the UCI resource pool associated with the second UCI. In some cases, the operations of this step refer to, or may be performed by, circuitry for transmitting and/or code for transmitting as described with reference to FIG. 17.

In some aspects,, based at least in part on the DMRS signal transmitted in the second time-frequency resource included in the UCI resource pool, the list of identifiers includes an identifier identifying the second time-frequency resource included in the UCI resource pool.

In some aspects, the identifier identifying the second time-frequency resource included in the UCI resource pool further indicates that access to the second time-frequency resource included in the PUSCH resource pool has not been granted; and the access to the second time-frequency resource included in the PUSCH resource pool has not been granted to the first UE based on the second UCI colliding with the third UCI transmitted by the second UE in the second time-frequency resource included in the UCI resource pool.

In some aspects, a third UCI, associated with a second UE, is transmitted in a third time-frequency resource included in the UCI resource pool and requests the access to the second time-frequency resource included in the PUSCH resource pool to transmit a third data transmission; and based on the third UCI associated with the second UE, the list of identifiers includes an identifier identifying the second time-frequency resource included in the UCI resource pool.

In some aspects, the identifier identifying the second time-frequency resource included in the UCI resource pool further indicates that access to the second time-frequency resource included in the PUSCH resource pool has not been granted to the first UE to transmit the second data transmission.

In some aspects, the method 1500 further includes receiving downlink control information (DCI), separate from the grant information, which includes: an identifier that identifies the second time-frequency resource included in the UCI resource pool in which the second UCI was transmitted by the first UE a third time-frequency resource included in the PUSCH resource pool that is allocated to the first UE to transmit the second data transmission. In some cases, the operations of this step refer to, or may be performed by, circuitry for receiving and/or code for receiving as described with reference to FIG. 17.

In some aspects, the method 1500 further includes transmitting the second data transmission using the third time-frequency resource included in the PUSCH resource pool. In some cases, the operations of this step refer to, or may be performed by, circuitry for transmitting and/or code for transmitting as described with reference to FIG. 17.

In some aspects, the method 1500 further includes receiving, from the network entity, access control configuration information enabling an intermediate access control mechanism and configuring the first UE to transmit the first UCI prior to transmitting the first data transmission. In some cases, the operations of this step refer to, or may be performed by, circuitry for receiving and/or code for receiving as described with reference to FIG. 17.

In some aspects, the method 1500 further includes receiving, from the network entity, additional access control configuration information disabling the intermediate access control mechanism and configuring the first UE to transmit a second data transmission in a second time-frequency resource included in the PUSCH resource pool without first transmitting a second UCI to request access to the second time-frequency resource included in the PUSCH resource pool to transmit the second data transmission. In some cases, the operations of this step refer to, or may be performed by, circuitry for receiving and/or code for receiving as described with reference to FIG. 17.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

### Example Communications Device(s)

FIG. 16 depicts aspects of an example communications device 1600. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1675 (e.g., a transmitter and/or a receiver) and/or a network interface 1685. The transceiver 1675 is configured to transmit and receive signals for the communications device 1600 via the antenna 1680, such as the various signals as described herein. The network interface 1685 is configured to obtain and send signals for the communications device 1600 via communication link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1640 via a bus 1670. In certain aspects, the computer-readable medium/memory 1640 is configured to store instructions (e.g., computer-executable code) that when executed by the one or more processors 1610, cause the one or more processors 1610 to perform the method 1400 described with respect to FIG. 14, or any aspect related to it. Note that reference to a processor of communications device 1600 performing a function may include one or more processors 1610 of communications device 1600 performing that function.

In the depicted example, the computer-readable medium/memory 1640 stores code (e.g., executable instructions), such as code for transmitting 1645, code for receiving 1650, code for decoding 1655, code for selecting 1660, and code for detecting 1665. Processing of the code for transmitting 1645, code for receiving 1650, code for decoding 1655, code for selecting 1660, and code for detecting 1665 may cause the communications device 1600 to perform the method 1400 described with respect to FIG. 14, or any aspect related to it.

The one or more processors 1610 include circuitry configured to implement (e.g., execute) the code stored in the computer-readable medium/memory 1640, including circuitry such as circuitry for transmitting 1615, circuitry for receiving 1620, circuitry for decoding 1625, circuitry for selecting 1630, and circuitry for detecting 1635. Processing with circuitry for transmitting 1615, circuitry for receiving 1620, circuitry for decoding 1625, circuitry for selecting 1630, and circuitry for detecting 1635 may cause the communications device 1600 to perform the method 1400 described with respect to FIG. 14, or any aspect related to it.

Various components of the communications device 1600 may provide means for performing the method 1400 described with respect to FIG. 14, or any aspect related to it. Means for transmitting, sending or outputting for transmission may include transceivers 332 and/or antenna(s) 334 of the BS 102 illustrated in FIG. 3 and/or the transceiver 1675 and the antenna 1680 of the communications device 1600 in FIG. 16. Means for receiving or obtaining may include transceivers 332 and/or antenna(s) 334 of the BS 102 illustrated in FIG. 3 and/or the transceiver 1675 and the antenna 1680 of the communications device 1600 in FIG. 16.

FIG. 17 depicts aspects of an example communications device 1700. In some aspects, communications device 1700 is a user equipment, such as UE 104 described above with respect to FIGS. 1 and 3.

The communications device 1700 includes a processing system 1705 coupled to the transceiver 1745 (e.g., a transmitter and/or a receiver). The transceiver 1745 is configured to transmit and receive signals for the communications device 1700 via the antenna 1750, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1725 via a bus 1740. In certain aspects, the computer-readable medium/memory 1725 is configured to store instructions (e.g., computer-executable code) that when executed by the one or more processors 1710, cause the one or more processors 1710 to perform the method 1500 described with respect to FIG. 15, or any aspect related to it. Note that reference to a processor performing a function of communications device 1700 may include one or more processors 1710 performing that function of communications device 1700.

In the depicted example, computer-readable medium/memory 1725 stores code (e.g., executable instructions), such as code for receiving 1730 and code for transmitting 1735. Processing of the code for receiving 1730 and code for transmitting 1735 may cause the communications device 1700 to perform the method 1500 described with respect to FIG. 15, or any aspect related to it.

The one or more processors 1710 include circuitry configured to implement (e.g., execute) the code stored in the computer-readable medium/memory 1725, including circuitry such as circuitry for receiving 1715 and circuitry for transmitting 1720. Processing with circuitry for receiving 1715 and circuitry for transmitting 1720 may cause the communications device 1700 to perform the method 1500 described with respect to FIG. 15, or any aspect related to it.

Various components of the communications device 1700 may provide means for performing the method 1500 described with respect to FIG. 15, or any aspect related to it. For example, means for transmitting, sending or outputting for transmission may include transceivers 354 and/or antenna(s) 352 of the UE 104 illustrated in FIG. 3 and/or the transceiver 1745 and the antenna 1750 of the communications device 1700 in FIG. 17. Means for receiving or obtaining may include transceivers 354 and/or antenna(s) 352 of the UE 104 illustrated in FIG. 3 and/or the transceiver 1745 and the antenna 1750 of the communications device 1700 in FIG. 17.

### Example Clauses

Implementation examples are described in the following numbered clauses:

Clause 1: A method for wireless communication by a network entity, comprising: transmitting, to one or more user equipments (UEs), resource configuration information configuring an uplink control information (UCI) resource pool including time-frequency resources for transmitting UCI and a separate physical uplink shared channel (PUSCH) resource pool including time-frequency resources for transmitting data transmissions, wherein the time-frequency resources included in the UCI resource pool are mapped to the time-frequency resources included in the PUSCH resource pool based on a UCI-to-PUSCH resource mapping; receiving, from a first UE of the one or more UEs, a first UCI in a first time-frequency resource included in the UCI resource pool requesting access to a first time-frequency resource included in the PUSCH resource pool to transmit a first data transmission, wherein the first UCI implicitly requests the access to the first time-frequency resource included in the PUSCH resource pool based on the first time-frequency resource included in the UCI resource pool being mapped to the first time-frequency resource included in the PUSCH resource pool according to the UCI-to-PUSCH resource mapping; transmitting, to the first UE after receiving the first UCI, grant information indicating that the access to the first time-frequency resource included in the PUSCH resource pool has been granted to transmit the first data transmission; and receiving, from the first UE, the first data transmission in the first time-frequency resource included in the PUSCH resource pool after transmitting the grant information.

Clause 2: The method of Clause 1, wherein the first UCI is transmitted using one of a physical uplink control channel (PUCCH) waveform or a PUSCH waveform.

Clause 3: The method of any one of Clauses 1-2, wherein the first UCI includes cyclic redundancy check (CRC) information for independent decoding of the first UCI.

Clause 4: The method of any one of Clauses 1-3, wherein: the first UCI includes one or more transmission parameters requested for the first data transmission; and the one or more transmission parameters include at least one of a modulation and coding scheme (MCS) or a payload size.

Clause 5: The method of any one of Clauses 1-4, wherein the first UCI includes identification information that uniquely identifies the first UCI.

Clause 6: The method of Clause 5, wherein the identification information comprises at least one of: a cell radio network temporary identifier (C-RNTI); an initial radio network temporary identifier (I-RNTI); an identifier that is shorter than a radio network temporary identifier; or a UCI identifier.

Clause 7: The method of any one of Clauses 1-6, wherein the UCI-to-PUSCH resource mapping comprises a one-to-one resource mapping in which one time-frequency resource included in the UCI resource pool maps to one time-frequency resource included in the PUSCH resource pool.

Clause 8: The method of Clause 7, wherein a total quantity of the time-frequency resources included in the UCI resource pool is equal to a total quantity of the time-frequency resources included in the PUSCH resource pool.

Clause 9: The method of Clause 8, wherein: the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

Clause 10: The method of Clause 9, wherein the bitmap includes at least a first bit that maps to the first time-frequency resource included in the UCI resource pool and indicates that the access to the first time-frequency resource included in the PUSCH resource pool has been granted to the first UE.

Clause 11: The method of Clause 9, further comprising: receiving, from the first UE of the one or more UEs, a second UCI in a second time-frequency resource included in the UCI resource pool requesting access to a second time-frequency resource included in the PUSCH resource pool to transmit a second data transmission; and receiving, from a second UE of the one or more UEs, a third UCI in the second time-frequency resource included in the UCI resource pool requesting access to the second time-frequency resource included in the PUSCH resource pool to transmit a third data transmission.

Clause 12: The method of Clause 11, wherein the second UCI from the first UE and the third UCI from the second UE collide in the second time-frequency resource included in the UCI resource pool.

Clause 13: The method of Clause 12, further comprising failing to decode both the second UCI and the third UCI based on the second UCI and the third UCI colliding in the second time-frequency resource included in the UCI resource pool.

Clause 14: The method of Clause 13, wherein, based on the failing to decode both the second UCI and the third UCI, the bitmap includes at least a second bit that maps to the second time-frequency resource included in the UCI resource pool and indicates that access to the second time-frequency resource included in the PUSCH resource pool has not been granted to the first UE or the second UE.

Clause 15: The method of Clause 12, further comprising successfully decoding one of the second UCI or the third UCI despite the second UCI and the third UCI colliding in the second time-frequency resource included in the UCI resource pool.

Clause 16: The method of Clause 15, wherein based on successfully decoding one of the second UCI or the third UCI, the bitmap includes at least a second bit that maps to the second time-frequency resource included in the UCI resource pool and indicates that access to the second time-frequency resource included in the PUSCH resource pool has been granted.

Clause 17: The method of Clause 16, further comprising receiving the second data transmission in the second time-frequency resource included in the PUSCH resource pool based on the second bit included in the bitmap.

Clause 18: The method of Clause 16, further comprising, based on the second bit indicating that the access to the second time-frequency resource included in the PUSCH resource pool has been granted, receiving: the second data transmission in the second time-frequency resource included in the PUSCH resource pool from the first UE the third data transmission in the second time-frequency resource included in the PUSCH resource pool from the second UE.

Clause 19: The method of Clause 18, further comprising successfully decoding one of the second data transmission from the first UE or the third data transmission from the second UE according to whichever of the second data transmission or the third data transmission has a higher signal strength.

Clause 20: The method of any one of Clauses 1-19, wherein the UCI-to-PUSCH resource mapping comprises a multiple-to-one resource mapping in which multiple different time-frequency resources included in the UCI resource pool map to one time-frequency resource included in the PUSCH resource pool.

Clause 21: The method of Clause 20, wherein a total quantity of the time-frequency resources included in the UCI resource pool is greater than a total quantity of the time-frequency resources included in the PUSCH resource pool.

Clause 22: The method of Clause 21, wherein: the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

Clause 23: The method of Clause 22, wherein the bitmap includes at least a first bit that maps to the first time-frequency resource included in the UCI resource pool and indicates that the access to the first time-frequency resource included in the PUSCH resource pool has been granted to the first UE.

Clause 24: The method of Clause 22, further comprising: receiving, from the first UE of the one or more UEs, a second UCI in a second time-frequency resource included in the UCI resource pool requesting access to a second time-frequency resource included in the PUSCH resource pool to transmit a second data transmission; and receiving, from a second UE of the one or more UEs, a third UCI in a third time-frequency resource included in the UCI resource pool requesting access to the second time-frequency resource included in the PUSCH resource pool to transmit a third data transmission.

Clause 25: The method of Clause 24, further comprising, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission.

Clause 26: The method of Clause 25, wherein, based on the selection, the bitmap includes at least: a first bit that maps to the second time-frequency resource included in the UCI resource pool and indicates that the access to the second time-frequency resource included in the PUSCH resource pool has not been granted to the first UE; and a second bit that maps to the third time-frequency resource included in the UCI resource pool and indicates that the access to the second time-frequency resource included in the PUSCH resource pool has been granted to the second UE.

Clause 27: The method of Clause 26, further comprising transmitting downlink control information (DCI), separate from the grant information, which includes: an identifier that identifies the second time-frequency resource included in the UCI resource pool in which the second UCI was received from the first UE a third time-frequency resource included in the PUSCH resource pool that is allocated to the first UE to transmit the second data transmission.

Clause 28: The method of Clause 27, further comprising receiving the second data transmission using the third time-frequency resource included in the PUSCH resource pool.

Clause 29: The method of Clause 21, wherein: the grant information comprises a group common physical downlink control channel (GC-PDCCH) that includes a list of identifiers; and each identifier in the list of identifiers identifies a different time-frequency resource included within the UCI resource pool and indicates whether access is granted to a time-frequency resource included in the PUSCH resource pool that maps to that different time-frequency resource included within the UCI resource pool.

Clause 30: The method of Clause 29, wherein the list of identifiers includes at least a first identifier that identifies the first time-frequency resource included within the UCI resource pool in which the first UCI is received from the first UE.

Clause 31: The method of Clause 30, wherein the first identifier comprises one of: a UCI time-frequency resource identifier; or a hash of a UCI time-frequency resource identifier.

Clause 32: The method of Clause 29, further comprising: receiving, from the first UE of the one or more UEs, a second UCI in a second time-frequency resource included in the UCI resource pool requesting access to a second time-frequency resource included in the PUSCH resource pool to transmit a second data transmission; and receiving, from a second UE of the one or more UEs, a third UCI in a third time-frequency resource included in the UCI resource pool requesting access to the second time-frequency resource included in the PUSCH resource pool to transmit a third data transmission.

Clause 33: The method of Clause 32, further comprising, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission.

Clause 34: The method of Clause 33, wherein, based on the selection: the list of identifiers includes at least a first identifier that identifies the third time-frequency resource included within the UCI resource pool in which the third UCI is received from the second UE; and the list of identifiers does not include a second identifier that identifiers the second time-frequency resource included within the UCI resource pool in which the second UCI is received from the first UE.

Clause 35: The method of Clause 34, further comprising transmitting downlink control information (DCI), separate from the grant information, which includes: an identifier that identifies the second time-frequency resource included in the UCI resource pool in which the second UCI was received from the first UE a third time-frequency resource included in the PUSCH resource pool that is allocated to the first UE to transmit the second data transmission.

Clause 36: The method of Clause 35, further comprising receiving the second data transmission using the third time-frequency resource included in the PUSCH resource pool.

Clause 37: The method of Clause 21, wherein: the grant information comprises a group common physical downlink control channel (GC-PDCCH) that includes a list of identifiers indicating which UEs of the one or more UEs are granted access to the time-frequency resources included within the PUSCH resource pool.

Clause 38: The method of Clause 37, wherein the list of identifiers includes at least a first identifier identifying the first UE and indicating that the access to the first time-frequency resource included in the PUSCH resource pool has been granted to the first UE.

Clause 39: The method of Clause 38, wherein the first identifier comprises one of: a UE identifier; or a hash of a UE identifier.

Clause 40: The method of Clause 37, further comprising: receiving, from the first UE of the one or more UEs, a second UCI in a second time-frequency resource included in the UCI resource pool requesting access to a second time-frequency resource included in the PUSCH resource pool to transmit a second data transmission; and receiving, from a second UE of the one or more UEs, a third UCI in a third time-frequency resource included in the UCI resource pool requesting access to the second time-frequency resource included in the PUSCH resource pool to transmit a third data transmission.

Clause 41: The method of Clause 40, further comprising, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission.

Clause 42: The method of Clause 41, wherein, based on the selection: the list of identifiers includes at least a first identifier identifying the second UE and indicating that access to the second time-frequency resource included in the PUSCH resource pool has been granted to the second UE; and the list of identifiers does not include a second identifier that identifies the first UE.

Clause 43: The method of Clause 42, further comprising transmitting downlink control information (DCI), separate from the grant information, which includes: the second identifier that identifies the first UE a third time-frequency resource included in the PUSCH resource pool that is allocated to the first UE to transmit the second data transmission.

Clause 44: The method of Clause 43, further comprising receiving the second data transmission using the third time-frequency resource included in the PUSCH resource pool.

Clause 45: The method of Clause 21, wherein the grant information comprises a list of identifiers of the time-frequency resources of the UCI resource pool that indicate which time-frequency resources included in the PUSCH resource pool have not been granted access to.

Clause 46: The method of Clause 45, wherein: the list of identifiers lacks an identifier of the first time-frequency resource included in the UCI resource pool; and the lack of the identifier of the first time-frequency resource included in the UCI resource pool indicates that the access to the first time-frequency resource included in the PUSCH resource pool has been granted to transmit the first data transmission.

Clause 47: The method of Clause 45, further comprising: receiving, from the first UE of the one or more UEs, a second UCI in a second time-frequency resource included in the UCI resource pool requesting access to a second time-frequency resource included in the PUSCH resource pool to transmit a second data transmission; and receiving, from a second UE of the one or more UEs, a third UCI in the second time-frequency resource included in the UCI resource pool requesting access to the second time-frequency resource included in the PUSCH resource pool to transmit a third data transmission.

Clause 48: The method of Clause 47, wherein the second UCI received from the first UE and the third UCI received from the second UE collide in the second time-frequency resource included in the UCI resource pool.

Clause 49: The method of Clause 48, further comprising failing to decode both the second UCI and the third UCI based on the second UCI and the third UCI colliding in the second time-frequency resource included in the UCI resource pool.

Clause 50: The method of Clause 49, further comprising detecting at least one demodulation reference signal (DMRS) signal in the second time-frequency resource included in the UCI resource pool associated with one of the second UCI received from the first UE or the third UCI received from the second UE.

Clause 51: The method of Clause 50, wherein the at least one DMRS signal is detected despite failing to decode both the second UCI received from the first UE and the third UCI received from the second UE.

Clause 52: The method of Clause 50, wherein, based on detecting the at least one DMRS signal in the second time-frequency resource included in the UCI resource pool, the list of identifiers includes an identifier identifying the second time-frequency resource included in the UCI resource pool.

Clause 53: The method of Clause 52, wherein the identifier identifying the second time-frequency resource included in the UCI resource pool further indicates that access to the second time-frequency resource included in the PUSCH resource pool has not been granted.

Clause 54: The method of Clause 21, further comprising: receiving, from the first UE of the one or more UEs, a second UCI in a second time-frequency resource included in the UCI resource pool requesting access to a second time-frequency resource included in the PUSCH resource pool to transmit a second data transmission receiving, from a second UE of the one or more UEs, a third UCI in a third time-frequency resource included in the UCI resource pool requesting access to the second time-frequency resource included in the PUSCH resource pool to transmit a third data transmission.

Clause 55: The method of Clause 54, further comprising, in response to receiving the second UCI requesting access to the second time-frequency resource included in the PUSCH resource pool and the third UCI requesting access to the second time-frequency resource included in the PUSCH resource pool, selecting the third time-frequency resource included in the UCI resource pool for granting access to the second time-frequency resource included in the PUSCH resource pool based on at least one of: a signal to noise (SNR) of the third UCI received in the third time-frequency resource included in the UCI resource pool a payload size indicated in the third UCI for the third data transmission.

Clause 56: The method of Clause 55, wherein, based on the selection, the grant information includes an identifier identifying the second time-frequency resource included in the UCI resource pool.

Clause 57: The method of Clause 56, wherein the identifier identifying the second time-frequency resource included in the UCI resource pool further indicates that access to the second time-frequency resource included in the PUSCH resource pool has not been granted to the first UE to transmit the second data transmission.

Clause 58: The method of Clause 57, further comprising transmitting downlink control information (DCI), separate from the grant information, which includes: an identifier that identifies the second time-frequency resource included in the UCI resource pool in which the second UCI was received from the first UE a third time-frequency resource included in the PUSCH resource pool that is allocated to the first UE to transmit the second data transmission.

Clause 59: The method of Clause 58, further comprising receiving the second data transmission using the third time-frequency resource included in the PUSCH resource pool.

Clause 60: The method of any one of Clauses 1-59, further comprising transmitting, to the first UE, access control configuration information enabling an intermediate access control mechanism and configuring the first UE to transmit the first UCI prior to transmitting the first data transmission.

Clause 61: The method of Clause 60, further comprising transmitting, to the first UE, additional access control configuration information disabling the intermediate access control mechanism and configuring the first UE to transmit a second data transmission in a second time-frequency resource included in the PUSCH resource pool without first transmitting a second UCI to request access to the second time-frequency resource included in the PUSCH resource pool to transmit the second data transmission.

Clause 62: A method for wireless communication by a first user equipment (UE), comprising: receiving, from a network entity, resource configuration information configuring an uplink control information (UCI) resource pool including time-frequency resources for transmitting UCI and a separate physical uplink shared channel (PUSCH) resource pool including time-frequency resources for transmitting data transmissions, wherein the time-frequency resources included in the UCI resource pool are mapped to the time-frequency resources included in the PUSCH resource pool based on a UCI-to-PUSCH resource mapping; transmitting, to the network entity, a first UCI in a first time-frequency resource included in the UCI resource pool requesting access to a first time-frequency resource included in the PUSCH resource pool to transmit a first data transmission, wherein the first UCI implicitly requests the access to the first time-frequency resource included in the PUSCH resource pool based on the first time-frequency resource included in the UCI resource pool being mapped to the first time-frequency resource included in the PUSCH resource pool according to the UCI-to-PUSCH resource mapping; receiving, from the network entity after transmitting the first UCI, grant information indicating that the access to the first time-frequency resource included in the PUSCH resource pool has been granted to transmit the first data transmission; and transmitting the first data transmission in the first time-frequency resource included in the PUSCH resource pool after receiving the grant information.

Clause 63: The method of Clause 62, wherein the first UCI is transmitted using one of a physical uplink control channel (PUCCH) waveform or a PUSCH waveform.

Clause 64: The method of any one of Clauses 62-63, wherein the first UCI includes cyclic redundancy check (CRC) information for independent decoding of the first UCI.

Clause 65: The method of any one of Clauses 62-64, wherein: the first UCI includes one or more transmission parameters requested for the first data transmission; and the one or more transmission parameters include at least one of a modulation and coding scheme (MCS) or a payload size.

Clause 66: The method of any one of Clauses 62-65, wherein the first UCI includes identification information that uniquely identifies the first UCI.

Clause 67: The method of Clause 66, wherein the identification information comprises at least one of: a cell radio network temporary identifier (C-RNTI); an initial radio network temporary identifier (I-RNTI); an identifier that is shorter than a radio network temporary identifier; or a UCI identifier.

Clause 68: The method of any one of Clauses 62-67, wherein the UCI-to-PUSCH resource mapping comprises a one-to-one resource mapping in which one time-frequency resource included in the UCI resource pool maps to one time-frequency resource included in the PUSCH resource pool.

Clause 69: The method of Clause 68, wherein a total quantity of the time-frequency resources included in the UCI resource pool is equal to a total quantity of the time-frequency resources included in the PUSCH resource pool.

Clause 70: The method of Clause 69, wherein: the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

Clause 71: The method of Clause 70, wherein the bitmap includes at least a first bit that maps to the first time-frequency resource included in the UCI resource pool and indicates that the access to the first time-frequency resource included in the PUSCH resource pool has been granted to the first UE.

Clause 72: The method of Clause 70, further comprising transmitting, to the network entity, a second UCI in a second time-frequency resource included in the UCI resource pool requesting access to a second time-frequency resource included in the PUSCH resource pool to transmit a second data transmission.

Clause 73: The method of Clause 72, wherein the second UCI transmitted in the second time-frequency resource included in the UCI resource pool collides with a third UCI transmitted by a second UE in the second time-frequency resource included in the UCI resource pool.

Clause 74: The method of Clause 73, wherein, based on the second UCI and the third UCI colliding in the second time-frequency resource included in the UCI resource pool, the bitmap includes at least a second bit that maps to the second time-frequency resource included in the UCI resource pool and indicates that access to the second time-frequency resource included in the PUSCH resource pool has not been granted to the first UE or the second UE.

Clause 75: The method of Clause 73, wherein, despite the second UCI and the third UCI colliding in the second time-frequency resource included in the UCI resource pool, the bitmap includes at least a second bit that maps to the second time-frequency resource included in the UCI resource pool and indicates that access to the second time-frequency resource included in the PUSCH resource pool has been granted.

Clause 76: The method of Clause 75, further comprising transmitting the second data transmission in the second time-frequency resource included in the PUSCH resource pool based on the second bit included in the bitmap.

Clause 77: The method of any one of Clauses 62-76, wherein the UCI-to-PUSCH resource mapping comprises a multiple-to-one resource mapping in which multiple different time-frequency resources included in the UCI resource pool map to one time-frequency resource included in the PUSCH resource pool.

Clause 78: The method of Clause 77, wherein a total quantity of the time-frequency resources included in the UCI resource pool is greater than a total quantity of the time-frequency resources included in the PUSCH resource pool.

Clause 79: The method of Clause 78, wherein: the grant information comprises a group common physical downlink control channel (GC-PDCCH) that includes a bitmap; the bitmap includes a plurality of bits equal to a quantity of the time-frequency resources included in the UCI resource pool; and each bit of the plurality of bits: maps to a different time-frequency resource of the time-frequency resources included in the UCI resource pool; and indicates whether access has been granted to a time-frequency resource included in the PUSCH resource pool that maps to that different time-frequency resource included in the UCI resource pool.

Clause 80: The method of Clause 79, wherein the bitmap includes at least a first bit that maps to the first time-frequency resource included in the UCI resource pool and indicates that the access to the first time-frequency resource included in the PUSCH resource pool has been granted to the first UE.

Clause 81: The method of Clause 79, further comprising transmitting, to the network entity, a second UCI in a second time-frequency resource included in the UCI resource pool requesting access to a second time-frequency resource included in the PUSCH resource pool to transmit a second data transmission.

Clause 82: The method of Clause 81, wherein the bitmap includes at least: a first bit that maps to the second time-frequency resource included in the UCI resource pool and indicates that the access to the second time-frequency resource included in the PUSCH resource pool has not been granted to the first UE; and a second bit that maps to a third time-frequency resource included in the UCI resource pool and indicates that the access to the second time-frequency resource included in the PUSCH resource pool has been granted to a second UE.

Clause 83: The method of Clause 82, further comprising receiving downlink control information (DCI), separate from the grant information, which includes: an identifier that identifies the second time-frequency resource included in the UCI resource pool in which the second UCI was transmitted by the first UE a third time-frequency resource included in the PUSCH resource pool that is allocated to the first UE to transmit the second data transmission.

Clause 84: The method of Clause 83, further comprising transmitting the second data transmission using the third time-frequency resource included in the PUSCH resource pool.

Clause 85: The method of Clause 78, wherein: the grant information comprises a group common physical downlink control channel (GC-PDCCH) that includes a list of identifiers; and each identifier in the list of identifiers identifies a different time-frequency resource included within the UCI resource pool and indicates whether access is granted to a time-frequency resource included in the PUSCH resource pool that maps to that different time-frequency resource included within the UCI resource pool.

Clause 86: The method of Clause 85, wherein the list of identifiers includes at least a first identifier that identifies the first time-frequency resource included within the UCI resource pool in which the first UCI was transmitted by the first UE.

Clause 87: The method of Clause 86, wherein the first identifier comprises one of: a UCI time-frequency resource identifier; or a hash of a UCI time-frequency resource identifier.

Clause 88: The method of Clause 85, further comprising transmitting, to the network entity, a second UCI in a second time-frequency resource included in the UCI resource pool requesting access to a second time-frequency resource included in the PUSCH resource pool to transmit a second data transmission.

Clause 89: The method of Clause 88, wherein: the list of identifiers includes at least a first identifier that identifies a third time-frequency resource included within the UCI resource pool in which a third UCI, associated with a second UE, was transmitted that requested access to the second time-frequency resource included in the PUSCH resource pool to transmit a third data transmission; and the list of identifiers does not include a second identifier that identifiers the second time-frequency resource included within the UCI resource pool in which the second UCI is received from the first UE.

Clause 90: The method of Clause 89, further comprising receiving downlink control information (DCI), separate from the grant information, which includes: an identifier that identifies the second time-frequency resource included in the UCI resource pool in which the second UCI was transmitted by the first UE a third time-frequency resource included in the PUSCH resource pool that is allocated to the first UE to transmit the second data transmission.

Clause 91: The method of Clause 90, further comprising transmitting the second data transmission using the third time-frequency resource included in the PUSCH resource pool.

Clause 92: The method of Clause 78, wherein: the grant information comprises a group common physical downlink control channel (GC-PDCCH) that includes a list of identifiers indicating which UEs of the one or more UEs are granted access to the time-frequency resources included within the PUSCH resource pool.

Clause 93: The method of Clause 92, wherein the list of identifiers includes at least a first identifier identifying the first UE and indicating that the access to the first time-frequency resource included in the PUSCH resource pool has been granted to the first UE.

Clause 94: The method of Clause 93, wherein the first identifier comprises one of: a UE identifier; or a hash of a UE identifier.

Clause 95: The method of Clause 92, further comprising transmitting, to the network entity, a second UCI in a second time-frequency resource included in the UCI resource pool requesting access to a second time-frequency resource included in the PUSCH resource pool to transmit a second data transmission.

Clause 96: The method of Clause 95, wherein: the list of identifiers includes at least a first identifier identifying a second UE and indicating that access to the second time-frequency resource included in the PUSCH resource pool has been granted to the second UE; and the list of identifiers does not include a second identifier that identifies the first UE.

Clause 97: The method of Clause 96, further comprising receiving downlink control information (DCI), separate from the grant information, which includes: the second identifier that identifies the first UE a third time-frequency resource included in the PUSCH resource pool that is allocated to the first UE to transmit the second data transmission.

Clause 98: The method of Clause 97, further comprising transmitting the second data transmission using the third time-frequency resource included in the PUSCH resource pool.

Clause 99: The method of Clause 78, wherein the grant information comprises a list of identifiers of the time-frequency resources of the UCI resource pool that indicate which time-frequency resources included in the PUSCH resource pool have not been granted access to.

Clause 100: The method of Clause 99, wherein: the list of identifiers lacks an identifier of the first time-frequency resource included in the UCI resource pool; and the lack of the identifier of the first time-frequency resource included in the UCI resource pool indicates that the access to the first time-frequency resource included in the PUSCH resource pool has been granted to transmit the first data transmission.

Clause 101: The method of Clause 99, further comprising transmitting, to the network entity, a second UCI in a second time-frequency resource included in the UCI resource pool requesting access to a second time-frequency resource included in the PUSCH resource pool to transmit a second data transmission.

Clause 102: The method of Clause 101, wherein the second UCI transmitted in the second time-frequency resource included in the UCI resource pool collides with a third UCI transmitted by a second UE in the second time-frequency resource included in the UCI resource pool.

Clause 103: The method of Clause 102, further comprising transmitting a demodulation reference signal (DMRS) signal in the second time-frequency resource included in the UCI resource pool associated with the second UCI.

Clause 104: The method of Clause 103, wherein, based at least in part on the DMRS signal transmitted in the second time-frequency resource included in the UCI resource pool, the list of identifiers includes an identifier identifying the second time-frequency resource included in the UCI resource pool.

Clause 105: The method of Clause 104, wherein: the identifier identifying the second time-frequency resource included in the UCI resource pool further indicates that access to the second time-frequency resource included in the PUSCH resource pool has not been granted; and the access to the second time-frequency resource included in the PUSCH resource pool has not been granted to the first UE based on the second UCI colliding with the third UCI transmitted by the second UE in the second time-frequency resource included in the UCI resource pool.

Clause 106: The method of Clause 101, wherein: a third UCI, associated with a second UE, is transmitted in a third time-frequency resource included in the UCI resource pool and requests the access to the second time-frequency resource included in the PUSCH resource pool to transmit a third data transmission; and based on the third UCI associated with the second UE, the list of identifiers includes an identifier identifying the second time-frequency resource included in the UCI resource pool.

Clause 107: The method of Clause 106, wherein the identifier identifying the second time-frequency resource included in the UCI resource pool further indicates that access to the second time-frequency resource included in the PUSCH resource pool has not been granted to the first UE to transmit the second data transmission.

Clause 108: The method of Clause 107, further comprising receiving downlink control information (DCI), separate from the grant information, which includes: an identifier that identifies the second time-frequency resource included in the UCI resource pool in which the second UCI was transmitted by the first UE a third time-frequency resource included in the PUSCH resource pool that is allocated to the first UE to transmit the second data transmission.

Clause 109: The method of Clause 108, further comprising transmitting the second data transmission using the third time-frequency resource included in the PUSCH resource pool.

Clause 110: The method of any one of Clauses 62-109, further comprising receiving, from the network entity, access control configuration information enabling an intermediate access control mechanism and configuring the first UE to transmit the first UCI prior to transmitting the first data transmission.

Clause 111: The method of Clause 110, further comprising receiving, from the network entity, additional access control configuration information disabling the intermediate access control mechanism and configuring the first UE to transmit a second data transmission in a second time-frequency resource included in the PUSCH resource pool without first transmitting a second UCI to request access to the second time-frequency resource included in the PUSCH resource pool to transmit the second data transmission.

Clause 112: An apparatus, comprising: at least one memory comprising executable instructions; and at least one processor configured to execute the executable instructions and cause the apparatus to perform a method in accordance with any combination of Clauses 1-111.

Clause 113: An apparatus, comprising means for performing a method in accordance with any combination of Clauses 1-111.

Clause 114: A non-transitory computer-readable medium comprising executable instructions that, when executed by at least one processor of an apparatus, cause the apparatus to perform a method in accordance with any combination of Clauses 1-111.

Clause 115: A computer program product embodied on a computer-readable storage medium comprising code for performing a method in accordance with any combination of Clauses 1-111.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A network entity for wireless communication, comprising:
at least one memory comprising computer-executable instructions; and
one or more processors configured to execute the computer-executable instructions to cause the network entity to:
transmit, to one or more user equipments (UEs), resource configuration information configuring an uplink control information (UCI) resource pool including time-frequency resources for transmitting UCI and a separate physical uplink shared channel (PUSCH) resource pool including time-frequency resources for transmitting data transmissions;
receive, from a first UE of the one or more UEs, a first UCI in a first time-frequency resource included in the UCI resource pool requesting access to a first time-frequency resource included in the PUSCH resource pool to transmit a first data transmission;
transmit, to the first UE after receiving the first UCI, grant information indicating that the access to the first time-frequency resource included in the PUSCH resource pool has been granted to transmit the first data transmission; and
receive, from the first UE, the first data transmission in the first time-frequency resource included in the PUSCH resource pool after transmitting the grant information.

2. The network entity of claim 1, wherein:
the first UCI is transmitted using one of a physical uplink control channel (PUCCH) waveform or a PUSCH waveform; and
the first UCI includes cyclic redundancy check (CRC) information for independent decoding of the first UCI.

3. The network entity of claim 1, wherein the first UCI includes one or more transmission parameters requested for the first data transmission; and the one or more transmission parameters include at least one of a modulation and coding scheme (MCS) or a payload size.

4. The network entity of claim 1, wherein
the first UCI includes identification information that uniquely identifies the first UCI; and
the identification information comprises at least one of:
a cell radio network temporary identifier (C-RNTI);
an initial radio network temporary identifier (I-RNTI);
an identifier that is shorter than a radio network temporary identifier; or
a UCI identifier.

5. The network entity of claim 1, wherein:
the time-frequency resources included in the UCI resource pool are mapped to the time-frequency resources included in the PUSCH resource pool based on a UCI-to-PUSCH resource mapping; and
the first UCI implicitly requests the access to the first time-frequency resource included in the PUSCH resource pool based on the first time-frequency resource included in the UCI resource pool being mapped to the first time-frequency resource included in the PUSCH resource pool according to the UCI-to-PUSCH resource mapping.

6. The network entity of claim 5, wherein:
the UCI-to-PUSCH resource mapping comprises a one-to-one resource mapping in which one time-frequency resource included in the UCI resource pool maps to one time-frequency resource included in the PUSCH resource pool; and
a total quantity of the time-frequency resources included in the UCI resource pool is equal to a total quantity of the time-frequency resources included in the PUSCH resource pool.

7. The network entity of claim 6, wherein:
the grant information comprises a group common physical downlink control channel (GC-PDCCH) that includes a bitmap;
the bitmap includes a plurality of bits equal to a quantity of the time-frequency resources included in the UCI resource pool;
each bit of the plurality of bits:
maps to a different time-frequency resource of the time-frequency resources included in the UCI resource pool; and
indicates whether access has been granted to a time-frequency resource included in the PUSCH resource pool that maps to that different time-frequency resource included in the UCI resource pool; and
the bitmap includes at least a first bit that maps to the first time-frequency resource included in the UCI resource pool and indicates that the access to the first time-frequency resource included in the PUSCH resource pool has been granted to the first UE.

8. The network entity of claim 7, wherein the one or more processors are further configured to cause the network entity to:
receive, from the first UE of the one or more UEs, a second UCI in a second time-frequency resource included in the UCI resource pool requesting access to a second time-frequency resource included in the PUSCH resource pool to transmit a second data transmission; and
receive, from a second UE of the one or more UEs, a third UCI in the second time-frequency resource included in the UCI resource pool requesting access to the second time-frequency resource included in the PUSCH resource pool to transmit a third data transmission, wherein the second UCI from the first UE and the third UCI from the second UE collide in the second time-frequency resource included in the UCI resource pool.

9. The network entity of claim 8, wherein, based on a failed decoding of both the second UCI and the third UCI due to the collision, the bitmap includes at least a second bit that maps to the second time-frequency resource included in the UCI resource pool and indicates that access to the second time-frequency resource included in the PUSCH resource pool has not been granted to the first UE or the second UE.

10. The network entity of claim 8, wherein:
the one or more processors are further configured to cause the network entity to successfully decode one of the second UCI or the third UCI despite the second UCI and the third UCI colliding in the second time-frequency resource included in the UCI resource pool; and
based on successfully decoding one of the second UCI or the third UCI, the bitmap includes at least a second bit that maps to the second time-frequency resource included in the UCI resource pool and indicates that access to the second time-frequency resource included in the PUSCH resource pool has been granted.

11. The network entity of claim 10, wherein the one or more processors are further configured to cause the network entity to:
receive, based on the second bit indicate that the access to the second time-frequency resource included in the PUSCH resource pool has been granted:
the second data transmission in the second time-frequency resource included in the PUSCH resource pool from the first UE; and
the third data transmission in the second time-frequency resource included in the PUSCH resource pool from the second UE; and
successfully decode one of the second data transmission from the first UE or the third data transmission from the second UE according to whichever of the second data transmission or the third data transmission has a higher signal strength.

12. The network entity of claim 5, wherein:
the UCI-to-PUSCH resource mapping comprises a multiple-to-one resource mapping in which multiple different time-frequency resources included in the UCI resource pool map to one time-frequency resource included in the PUSCH resource pool; and
a total quantity of the time-frequency resources included in the UCI resource pool is greater than a total quantity of the time-frequency resources included in the PUSCH resource pool.

13. The network entity of claim 12, wherein:
the grant information comprises a group common physical downlink control channel (GC-PDCCH) that includes a bitmap;
the bitmap includes a plurality of bits equal to a quantity of the time-frequency resources included in the UCI resource pool; and
each bit of the plurality of bits:
maps to a different time-frequency resource of the time-frequency resources included in the UCI resource pool; and
indicates whether access has been granted to a time-frequency resource included in the PUSCH resource pool that maps to that different time-frequency resource included in the UCI resource pool; and
the bitmap includes at least a first bit that maps to the first time-frequency resource included in the UCI resource pool and indicates that the access to the first time-frequency resource included in the PUSCH resource pool has been granted to the first UE.

14. The network entity of claim 13, wherein the one or more processors are further configured to cause the network entity to:
receive, from the first UE of the one or more UEs, a second UCI in a second time-frequency resource included in the UCI resource pool requesting access to a second time-frequency resource included in the PUSCH resource pool to transmit a second data transmission; and
receive, from a second UE of the one or more UEs, a third UCI in a third time-frequency resource included in the UCI resource pool requesting access to the second time-frequency resource included in the PUSCH resource pool to transmit a third data transmission.

15. The network entity of claim 14, wherein:
the one or more processors are further configured to cause the network entity to, in response to receive the second UCI requesting access to the second time-frequency resource included in the PUSCH resource pool and the third UCI requesting access to the second time-frequency resource included in the PUSCH resource pool, select the third time-frequency resource included in the UCI resource pool for granting access to the second time-frequency resource included in the PUSCH resource pool based on at least one of:
a signal to noise (SNR) of the third UCI received in the third time-frequency resource included in the UCI resource pool; or
a payload size indicated in the third UCI for the third data transmission; and
based on the selection, the bitmap includes at least:
a first bit that maps to the second time-frequency resource included in the UCI resource pool and indicates that the access to the second time-frequency resource included in the PUSCH resource pool has not been granted to the first UE; and
a second bit that maps to the third time-frequency resource included in the UCI resource pool and indicates that the access to the second time-frequency resource included in the PUSCH resource pool has been granted to the second UE.

16. The network entity of claim 15, wherein the one or more processors are further configured to cause the network entity to:
transmit downlink control information (DCI), separate from the grant information, which includes:
an identifier that identifies the second time-frequency resource included in the UCI resource pool in which the second UCI was received from the first UE; and
a third time-frequency resource included in the PUSCH resource pool that is allocated to the first UE to transmit the second data transmission; and
receive the second data transmission using the third time-frequency resource included in the PUSCH resource pool.

17. The network entity of claim 12, wherein:
the grant information comprises a group common physical downlink control channel (GC-PDCCH) that includes a list of identifiers; and
each identifier in the list of identifiers identifies a different time-frequency resource included within the UCI resource pool and indicates whether access is granted to a time-frequency resource included in the PUSCH resource pool that maps to that different time-frequency resource included within the UCI resource pool;
the list of identifiers includes at least a first identifier that identifies the first time-frequency resource included within the UCI resource pool in which the first UCI is received from the first UE; and
the first identifier comprises one of: a UCI time-frequency resource identifier; or a hash of a UCI time-frequency resource identifier.

18. The network entity of claim 17, wherein:
the one or more processors are further configured to cause the network entity to:
receive, from the first UE of the one or more UEs, a second UCI in a second time-frequency resource included in the UCI resource pool requesting access to a second time-frequency resource included in the PUSCH resource pool to transmit a second data transmission; and
receive, from a second UE of the one or more UEs, a third UCI in a third time-frequency resource included in the UCI resource pool requesting access to the second time-frequency resource included in the PUSCH resource pool to transmit a third data transmission; and
in response to receiving the second UCI requesting access to the second time-frequency resource included in the PUSCH resource pool and the third UCI requesting access to the second time-frequency resource included in the PUSCH resource pool, select the third time-frequency resource included in the UCI resource pool for granting access to the second time-frequency resource included in the PUSCH resource pool based on at least one of:
a signal to noise (SNR) of the third UCI received in the third time-frequency resource included in the UCI resource pool; or
a payload size indicated in the third UCI for the third data transmission; and
based on the selection:
the list of identifiers includes at least a first identifier that identifies the third time-frequency resource included within the UCI resource pool in which the third UCI is received from the second UE; and
the list of identifiers does not include a second identifier that identifiers the second time-frequency resource included within the UCI resource pool in which the second UCI is received from the first UE.

19. The network entity of claim 18, wherein the one or more processors are further configured to cause the network entity to:
transmit downlink control information (DCI), separate from the grant information, which includes:
an identifier that identifies the second time-frequency resource included in the UCI resource pool in which the second UCI was received from the first UE; and
a third time-frequency resource included in the PUSCH resource pool that is allocated to the first UE to transmit the second data transmission; and
receive the second data transmission using the third time-frequency resource included in the PUSCH resource pool.

20. The network entity of claim 12, wherein:
the grant information comprises a group common physical downlink control channel (GC-PDCCH) that includes a list of identifiers indicating which UEs of the one or more UEs are granted access to the time-frequency resources included within the PUSCH resource pool;
the list of identifiers includes at least a first identifier identifying the first UE and indicating that the access to the first time-frequency resource included in the PUSCH resource pool has been granted to the first UE; and
the first identifier comprises one of:
a UE identifier; or
a hash of a UE identifier.

21. The network entity of claim 20, wherein:
the one or more processors are further configured to cause the network entity to:
receive, from the first UE of the one or more UEs, a second UCI in a second time-frequency resource included in the UCI resource pool requesting access to a second time-frequency resource included in the PUSCH resource pool to transmit a second data transmission; and
receive, from a second UE of the one or more UEs, a third UCI in a third time-frequency resource included in the UCI resource pool requesting access to the second time-frequency resource included in the PUSCH resource pool to transmit a third data transmission; and
in response to receiving the second UCI requesting access to the second time-frequency resource included in the PUSCH resource pool and the third UCI requesting access to the second time-frequency resource included in the PUSCH resource pool, select the third time-frequency resource included in the UCI resource pool for granting access to the second time-frequency resource included in the PUSCH resource pool based on at least one of:
a signal to noise (SNR) of the third UCI received in the third time-frequency resource included in the UCI resource pool; or
a payload size indicated in the third UCI for the third data transmission; and
based on the selection:
the list of identifiers includes at least a first identifier identifying the second UE and indicating that access to the second time-frequency resource included in the PUSCH resource pool has been granted to the second UE; and
the list of identifiers does not include a second identifier that identifies the first UE.

22. The network entity of claim 21, wherein the one or more processors are further configured to cause the network entity to:
transmit downlink control information (DCI), separate from the grant information, which includes:
the second identifier that identifies the first UE; and
a third time-frequency resource included in the PUSCH resource pool that is allocated to the first UE to transmit the second data transmission; and
receive the second data transmission using the third time-frequency resource included in the PUSCH resource pool.

23. The network entity of claim 12, wherein:
the grant information comprises a list of identifiers of the time-frequency resources of the UCI resource pool that indicate which time-frequency resources included in the PUSCH resource pool have not been granted access to;
the list of identifiers lacks an identifier of the first time-frequency resource included in the UCI resource pool; and
the lack of the identifier of the first time-frequency resource included in the UCI resource pool indicates that the access to the first time-frequency resource included in the PUSCH resource pool has been granted to transmit the first data transmission.

24. The network entity of claim 23, wherein the one or more processors are further configured to cause the network entity to:
receive, from the first UE of the one or more UEs, a second UCI in a second time-frequency resource included in the UCI resource pool requesting access to a second time-frequency resource included in the PUSCH resource pool to transmit a second data transmission; and
receive, from a second UE of the one or more UEs, a third UCI in the second time-frequency resource included in the UCI resource pool requesting access to the second time-frequency resource included in the PUSCH resource pool to transmit a third data transmission.

25. The network entity of claim 24, wherein:
the one or more processors are further configured to cause the network entity to detect at least one demodulation reference signal (DMRS) signal in the second time-frequency resource included in the UCI resource pool associated with one of the second UCI received from the first UE or the third UCI received from the second UE;
the at least one DMRS signal is detected despite a failed decoding of both the second UCI received from the first UE and the third UCI received from the second UE;
based on detecting the at least one DMRS signal in the second time-frequency resource included in the UCI resource pool, the list of identifiers includes an identifier identifying the second time-frequency resource included in the UCI resource pool; and
the identifier identifying the second time-frequency resource included in the UCI resource pool further indicates that access to the second time-frequency resource included in the PUSCH resource pool has not been granted.

26. The network entity of claim 12, wherein:
the one or more processors are further configured to cause the network entity to:
receive, from the first UE of the one or more UEs, a second UCI in a second time-frequency resource included in the UCI resource pool requesting access to a second time-frequency resource included in the PUSCH resource pool to transmit a second data transmission;
receive, from a second UE of the one or more UEs, a third UCI in a third time-frequency resource included in the UCI resource pool requesting access to the second time-frequency resource included in the PUSCH resource pool to transmit a third data transmission; and
in response to receiving the second UCI requesting access to the second time-frequency resource included in the PUSCH resource pool and the third UCI requesting access to the second time-frequency resource included in the PUSCH resource pool, select the third time-frequency resource included in the UCI resource pool for granting access to the second time-frequency resource included in the PUSCH resource pool based on at least one of:
a signal to noise (SNR) of the third UCI received in the third time-frequency resource included in the UCI resource pool; or
a payload size indicated in the third UCI for the third data transmission;
based on the selection, the grant information includes an identifier identifying the second time-frequency resource included in the UCI resource pool; and
the identifier identifying the second time-frequency resource included in the UCI resource pool further indicates that access to the second time-frequency resource included in the PUSCH resource pool has not been granted to the first UE to transmit the second data transmission.

27. The network entity of claim 26, wherein the one or more processors are further configured to cause the network entity to:
transmit downlink control information (DCI), separate from the grant information, which includes:
an identifier that identifies the second time-frequency resource included in the UCI resource pool in which the second UCI was received from the first UE; and
a third time-frequency resource included in the PUSCH resource pool that is allocated to the first UE to transmit the second data transmission; and
receive the second data transmission using the third time-frequency resource included in the PUSCH resource pool.

28. A method for wireless communication by a network entity, comprising:
transmitting, to one or more user equipments (UEs), resource configuration information configuring an uplink control information (UCI) resource pool including time-frequency resources for transmitting UCI and a separate physical uplink shared channel (PUSCH) resource pool including time-frequency resources for transmitting data transmissions;
receiving, from a first UE of the one or more UEs, a first UCI in a first time-frequency resource included in the UCI resource pool requesting access to a first time-frequency resource included in the PUSCH resource pool to transmit a first data transmission;
transmitting, to the first UE after receiving the first UCI, grant information indicating that the access to the first time-frequency resource included in the PUSCH resource pool has been granted to transmit the first data transmission; and
receiving, from the first UE, the first data transmission in the first time-frequency resource included in the PUSCH resource pool after transmitting the grant information.

29. A method for wireless communication by a first user equipment (UE), comprising:
receiving, from a network entity, resource configuration information configuring an uplink control information (UCI) resource pool including time-frequency resources for transmitting UCI and a separate physical uplink shared channel (PUSCH) resource pool including time-frequency resources for transmitting data transmissions;
transmitting, to the network entity, a first UCI in a first time-frequency resource included in the UCI resource pool requesting access to a first time-frequency resource included in the PUSCH resource pool to transmit a first data transmission;
receiving, from the network entity after transmitting the first UCI, grant information indicating that the access to the first time-frequency resource included in the PUSCH resource pool has been granted to transmit the first data transmission; and
transmitting the first data transmission in the first time-frequency resource included in the PUSCH resource pool after receiving the grant information.

30. A first user equipment (UE) for wireless communication, comprising:
at least one memory comprising computer-executable instructions; and
one or more processors configured to execute the computer-executable instructions to cause the first UE to:
receive, from a network entity, resource configuration information configuring an uplink control information (UCI) resource pool including time-frequency resources for transmitting UCI and a separate physical uplink shared channel (PUSCH) resource pool including time-frequency resources for transmitting data transmissions;
transmit, to the network entity, a first UCI in a first time-frequency resource included in the UCI resource pool requesting access to a first time-frequency resource included in the PUSCH resource pool to transmit a first data transmission;
receive, from the network entity after transmitting the first UCI, grant information indicating that the access to the first time-frequency resource included in the PUSCH resource pool has been granted to transmit the first data transmission; and
transmit the first data transmission in the first time-frequency resource included in the PUSCH resource pool after receiving the grant information.
